(19) United States
(12) Patent Application Publication
(10) Pub. No.: US 2009/0153751 A1
(43) Pub. Date: Jun. 18, 2009

(54) Image Projection System, Terminal Apparatus, and Computer-Readable Recording Medium Recording Program

(75) Inventors: Hirotaka Asakura, Nagoya-shi, Aichi-ken (JP); Katsuhiro Amano, Toyota-shi, Aichi-ken (JP)

Correspondence Address: BANNER & WITCOFF, LTD.;ATTORNEYS FOR CLIENT NO. 016689, 1100 13th STREET, N.W., SUITE 1200, WASHINGTON, DC, 20005-4051, US

(73) Assignee: Brother Kogyo Kabushiki Kaisha, Nagoya-shi, Aichi (JP)

(21) Appl. No.: 12/337,173

(22) Filed: Dec. 17, 2008

(30) Foreign Application Priority Data
Dec. 18, 2007 (JP) 2007-326397

(51) Int. Cl. H04N 9/31

(52) U.S. Cl. 348/744; 348/E09.025

(57) ABSTRACT

In a case where display of an image is terminated in a predetermined display region and, then, the image is generated again based on an application program corresponding to the image of which the display is terminated, the image is generated in a region other than the predetermined display region without being projected in a visually recognizable manner. A terminal apparatus generates image data based on an application program, and terminates display of an image based on the image data. An image projection apparatus acquires a plurality of pieces of image data of images in predetermined display regions of a plurality of terminal apparatuses, combines the plurality of pieces of image data to generate composite image data, and projects an image based on the composite image data. The terminal apparatus may change a display position of the image to a display region other than the predetermined display region.

### CROSS-REFERENCE TO RELATED APPLICATION(S)

This application is based on and claims the benefit of priority from Japanese Patent Application No. 2007-326397 filed on Dec. 18, 2007; the entire contents of which are incorporated herein by reference.

### BACKGROUND OF THE INVENTION

1. Field of the Invention

The present invention relates to an image projection system, a terminal apparatus, and a computer-readable recording medium recording a program. In particular, the present invention relates to an image projection system that allows a plurality of users to efficiently conduct collaborative operations and sharing of information, a terminal apparatus, and a computer-readable recording medium recording a program.

2. Description of the Related Art

As one example of an image projection apparatus, heretofore, there has been widely used a projector or the like. In the projector, a liquid crystal display device receives image information from a computer apparatus or the like to display an image based on the image information and is irradiated with light, so that the image is projected onto a projection screen while being enlarged.

A projector of this type is frequently used in a meeting in which a plurality of persons participate, and for other purposes. Use of such a projector allows the plurality of participants to conduct a discussion in a state that the plurality of participants see a single image which is projected onto a screen while being enlarged.

In many instances, on the other hand, a plurality of terminal apparatuses are connected to one another through a communication path such as a network in order to allow users of the terminal apparatuses to efficiently conduct sharing of information and collaborative operations in a meeting and the like. For example, Japanese Unexamined Patent Publication No. 2006-031359 discloses a meeting support system configured with a server and a plurality of terminal apparatuses. Herein, the server combines a plurality of pieces of image data transmitted from the plurality of terminal apparatuses, transmits composite image data to each terminal apparatus. Then, each terminal apparatus displays an image based on the composite image data on a monitor thereof. With this configuration, thus, this system allows participants of a meeting to conduct a discussion in a state that the participants see the single image displayed on the respective terminal apparatuses.

As another example of such a system, a plurality of terminal apparatuses transmit images displayed in predetermined display regions thereof to a server. A user of the terminal apparatus, who intends to openly show the image, places the image in the predetermined display region. Conversely, a user of the terminal apparatus, who does not intend to openly show the image, places the image in a region other than the predetermined display region. With this configuration, each participant of a meeting can control showing of an image through the terminal apparatus.

### SUMMARY OF THE INVENTION

In the image projection systems described above, when display of an image is terminated, for example, when an application program is terminated, a position where the display is terminated is stored. Then, when the application is started up again to generate the image, the image is displayed at the position stored upon termination of the preceding display. In some instances, a user does not intend to openly show the image upon generation of the image even though the image is shown openly upon termination of the display. However, there is a possibility that each participant of a meeting readily sees the image irrespective of an intention of the user. Of course, in the case where the display of the image based on the application is terminated in the predetermined display region, even when a different image is generated, the same application is started up again, so that the generated image is displayed in the predetermined display region. Consequently, there is a possibility that each participant readily sees the image.

The present invention has been devised in view of the problems described above and provides an image projection system that brings about such an advantage that in a case where display of an image, which is projected by an image projection apparatus, is terminated in a predetermined display region and, then, the image is generated again based on an application program corresponding to the image of which the display is terminated, the image can be generated in a region other than the predetermined display region without being projected in a visually recognizable manner. The present invention also provides a terminal apparatus and a computer-readable recording medium recording a program.

According to one aspect of the present invention, there is provided an image projection system including: a plurality of terminal apparatuses; and an image projection apparatus that acquires image data from each terminal apparatus via a communication path and projects an image based on the image data. Herein, the image projection apparatus includes: an image acquisition unit that acquires a plurality of pieces of image data of images located in predetermined display regions of the respective terminal apparatuses via the communication path; an image processing unit that combines the plurality of pieces of image data of the images located in the predetermined display regions of the respective terminal apparatuses; and an image projection unit that projects an image based on composite image data generated by the image processing unit. Each terminal apparatus includes: an application program control unit that controls a predetermined application program; an image generation unit that generates image data based on the application program controlled by the application program control unit; a display control unit that controls display of an image based on the image data generated by the image generation unit and controls termination of the display; a predetermined region image transmission unit that, when a position of the image based on the image data generated by the image generation unit is in the predetermined display region, partially or entirely transmits the image data of the image to the image projection apparatus via the communication path; and an image display position change unit that changes the display position of the image to a display region other than the predetermined display region, on conditions that the display control unit terminates in the predetermined display region the display of the image generated based on the application program controlled by the application program control unit and the image generation unit generates the image based on the application program again. Moreover, there are also provided a terminal apparatus of the image projection system, and a computer-readable recording medium recording a program for the image projection system.

### BRIEF DESCRIPTION OF THE DRAWINGS

FIG. 1 shows a general system configuration of an image projection system in one embodiment of the present invention;

FIG. 2 shows a schematic configuration of an image projection apparatus for use in the image projection system in the embodiment;

FIG. 3 shows a schematic configuration of a terminal apparatus for use in the image projection system in the embodiment;

FIG. 4 shows a sequence diagram of one example of an action performed by the image projection system in the embodiment;

FIG. 5 shows a sequence diagram of one example of an action performed by the image projection system in the embodiment;

FIG. 6 shows a sequence diagram of one example of an action performed by the image projection system in the embodiment;

FIG. 7 shows a sequence diagram of one example of an action performed by the image projection system in the embodiment;

FIG. 8 shows a sequence diagram of one example of an action performed by the image projection system in the embodiment;

FIG. 9 shows a configuration of the image projection apparatus in the embodiment;

FIG. 10 shows a configuration of the terminal apparatus in the embodiment;

FIG. 11 shows one example of a shared window management table stored in the image projection apparatus in the embodiment;

FIG. 12 shows one example of a terminal connection management table stored in the image projection apparatus in the embodiment;

FIG. 13 shows one example of a pointer information management table stored in the image projection apparatus in the embodiment;

FIG. 14 shows a flowchart of a main process executed by the image projection apparatus in the embodiment;

FIG. 15 shows a flowchart of a main process executed by the terminal apparatus in the embodiment;

FIG. 16 shows a flowchart of a connecting process executed by the terminal apparatus in the embodiment;

FIG. 17 shows a flowchart of a window information updating process executed by the terminal apparatus in the embodiment;

FIG. 18 shows a flowchart of a shared window information updating process executed by the terminal apparatus in the embodiment;

FIG. 19 shows a flowchart of an operation input reproducing process executed by the terminal apparatus in the embodiment;

FIG. 20 shows a flowchart of an operation input transferring process executed by the terminal apparatus in the embodiment;

FIG. 21 shows a flowchart of an image data transmitting process executed by the terminal apparatus in the embodiment;

FIG. 22 shows a sequence diagram of one example of an action performed by the image projection system in a second embodiment of the present invention;

FIG. 23 shows a flowchart of an operation input reproducing process executed by the terminal apparatus in the second embodiment;

FIG. 24 shows a sequence diagram of one example of an action performed by the image projection system in a third embodiment of the present invention;

FIG. 25 shows a flowchart of a window information updating process executed by the image projection apparatus in the third embodiment;

FIG. 26 shows a sequence diagram of one example of an action performed by the image projection system in a fourth embodiment of the present invention;

FIG. 27 shows a flowchart of a window sharing permission determining process executed by the image projection apparatus in the fourth embodiment;

FIG. 28 shows a sequence diagram of one example of an action performed by the image projection system in a fifth embodiment of the present invention;

FIG. 29 shows a flowchart of an operation input sorting process executed by the image projection apparatus in the fifth embodiment;

FIG. 30 shows a flowchart of a window termination determining process executed by the image projection apparatus in the fifth embodiment;

FIG. 31 shows a sequence diagram of one example of an action performed by the image projection system in a sixth embodiment of the present invention;

FIG. 32 shows a flowchart of a window information updating process executed by the image projection apparatus in the sixth embodiment; and

FIG. 33 shows a general system configuration of the image projection system in another embodiment of the present invention.

### DESCRIPTION OF THE PREFERRED EMBODIMENTS

### 1. Outline of Image Projection System

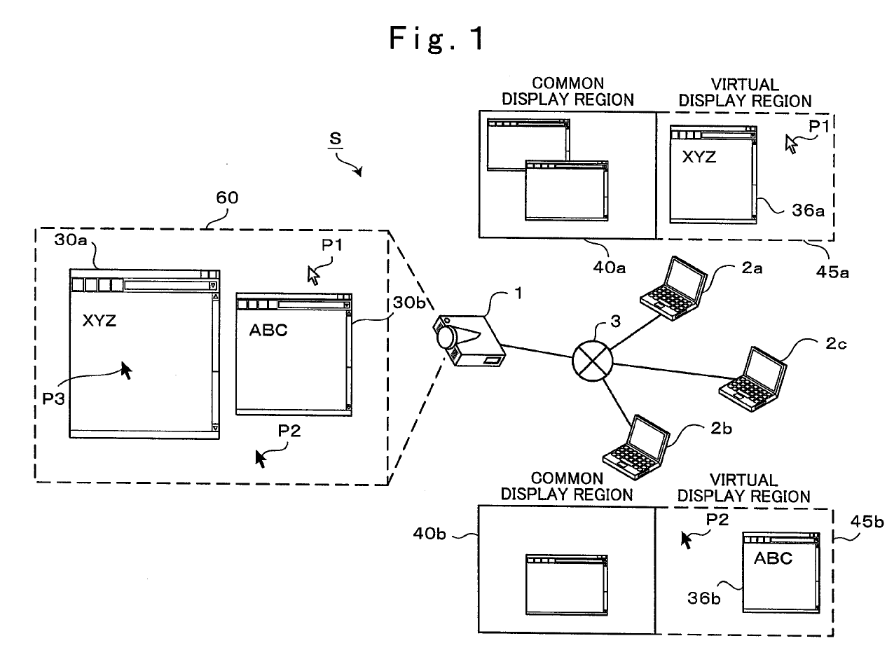

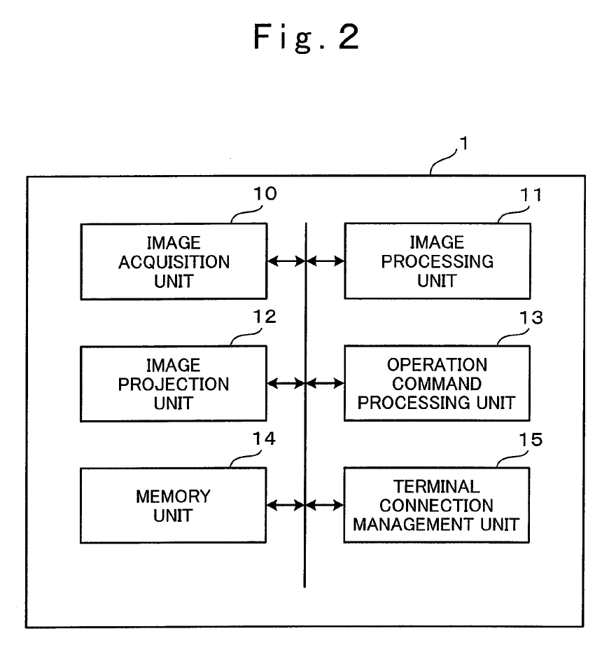

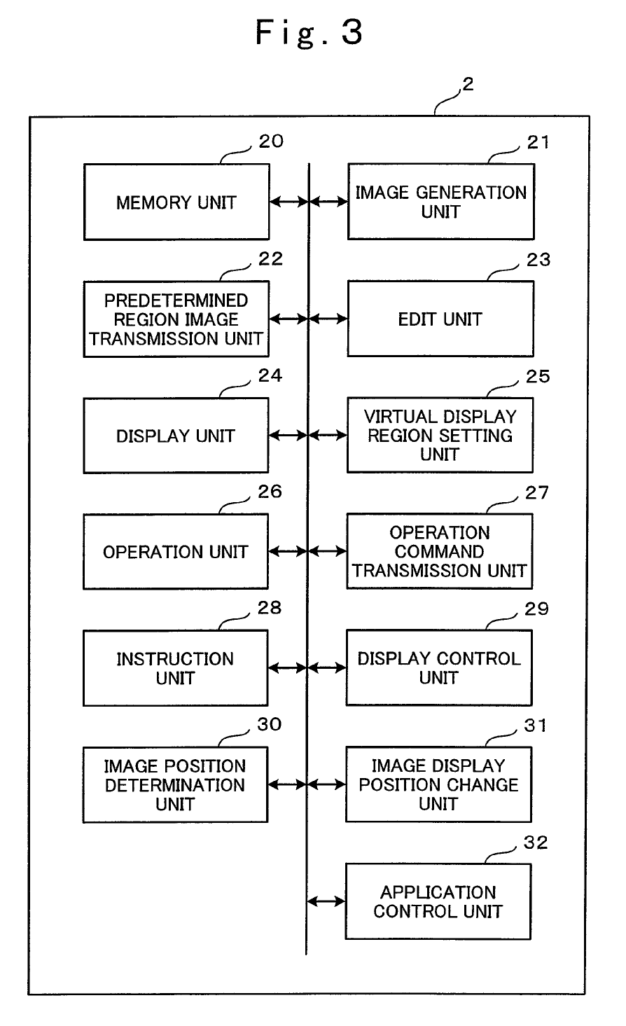

With reference to the drawings, hereinafter, description will be given of an image projection system in one embodiment of the present invention. FIG. 1 shows a general system configuration of the image projection system in this embodiment. FIG. 2 shows a schematic configuration of an image projection apparatus for use in the image projection system in this embodiment. FIG. 3 shows a schematic configuration of a terminal apparatus for use in the image projection system in this embodiment.

As shown in FIG. 1, an image projection system S in this embodiment is configured with an image projection apparatus 1 and a plurality of terminal apparatuses (herein, terminal apparatuses 2a, 2b and 2c) each connected to the image projection apparatus 1 via a communication path 3. In the image projection system S, each of the terminal apparatuses 2a, 2b and 2c executes an application program (hereinafter, simply referred to as “application” in some instances) to generate an image, and the image projection apparatus 1 combines a plurality of pieces of image data of images located in predetermined display regions of the respective terminal apparatuses 2a, 2b and 2c to generate composite image data and projects an image based on the composite image data onto a large screen. In the image projection system S, moreover, any one of the terminal apparatuses 2a, 2b and 2c or a remote controller (not shown) transmits an image operation command for operating a predetermined image, which is selected from images projected by the image projection apparatus 1, to another terminal apparatus via the image projection apparatus 1, thereby editing not only the image generated based on the application executed thereby but also the image generated based on the application executed by another terminal apparatus among the images projected on the large screen. In other words, the image projection system S described above includes a plurality of terminal apparatuses and an image projection apparatus that acquires image data from each terminal apparatus via a communication path and projects an image based on the image data.

In this embodiment, description will be given of a case where two terminal apparatuses are connected to the image projection apparatus 1; however, the number of terminal apparatuses to be connected to the image projection apparatus 1 is not limited to two. Moreover, in a case where any one of the terminal apparatuses 2a and 2b is described, the relevant terminal apparatus is represented as the terminal apparatus 2 in some instances.

As shown in FIG. 2, the image projection apparatus 1 of the image projection system S in this embodiment includes an image acquisition unit 10, an image processing unit 11, an image projection unit 12, an operation command processing unit 13, a memory unit 14 and a terminal connection management unit 15. As shown in FIG. 3, moreover, the terminal apparatus 2 of the image projection system S in this embodiment includes a memory unit 20, an image generation unit 21, a predetermined region image transmission unit 22, an edit unit 23, a display unit 24, a virtual display region setting unit 25, an operation unit 26, an operation command transmission unit 27, an instruction unit 28, a display control unit 29, an image position determination unit 30, an image display position change unit 31 and an application control unit 32.

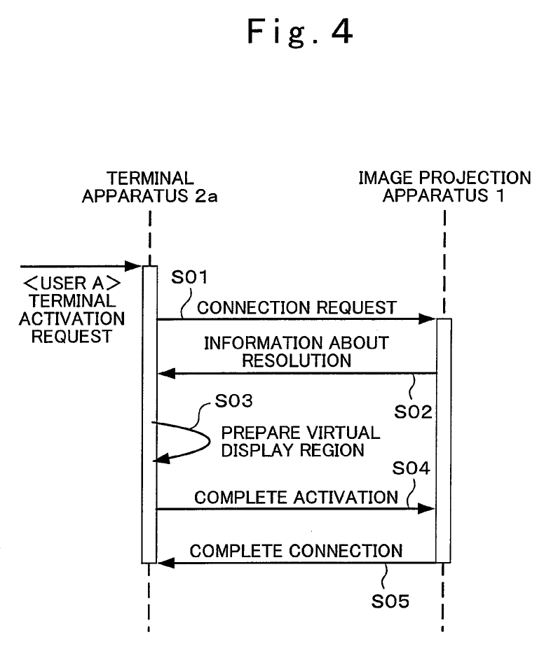

As a general action, mainly, the image projection system S in this embodiment sequentially performs a connecting action for establishing connection between the image projection apparatus 1 and the terminal apparatus 2, an projecting action for combining a plurality of pieces of image data acquired from the respective terminal apparatuses 2 to generate composite image data and projecting an image based on the composite image data, and an editing action for editing an arbitrary data file in accordance with a request from the terminal apparatus 2 in this order. With reference to FIGS. 4 to 8, hereinafter, schematic description will be given of one example of a flow of the general action performed by the image projection system S in this embodiment.

With reference to FIG. 4, first, description will be given of the connecting action. FIG. 4 shows a sequence diagram of one example of the connecting action performed by the image projection system S in this embodiment. Specifically, this action is performed by each of the terminal apparatuses 2a and 2b. Herein, the terminal apparatus 2a is described representatively.

As shown in FIG. 4, first, a user A of the terminal apparatus 2a conducts an activating operation for the terminal apparatus 2a through the operation unit 26, so that the terminal apparatus 2a allows the operation command transmission unit 27 to transmit a connection request signal to the image projection apparatus 1 (step S10). Upon reception of the connection request signal, next, the image projection apparatus 1 allows the image acquisition unit 10 to transmit information about resolution, which is set by the image projection apparatus 1, to the terminal apparatus 2a in order to unify resolution of a plurality of pieces of image data acquired from the respective terminal apparatuses 2 (step S02).

Next, the terminal apparatus 2a prepares a virtual display region as a predetermined display region, based on the received resolution information (step S03). As shown in FIG. 1, in the terminal apparatuses 2a and 2b, the virtual display region described above corresponds to virtual display regions 45a and 45b adjoining to common display regions 40a and 40b of the respective display units 24, and the virtual display regions 45a and 45b are set by the virtual image region setting units 25. In a case where any one of the common display regions 40a and 40b is described, the relevant common display region is represented as the common display region 40 in some instances. In a case where any one of the virtual display regions 45a and 45b is described, the relevant virtual display region is represented as the virtual display region 45 in some instances.

In this embodiment, the virtual display region 45 is set as the predetermined display region as described above. However, this predetermined display region may be provided, for example, as a part of the display region of the display unit 24 of the terminal apparatus 2.

After preparation of the virtual display region 45a in step S03, the terminal apparatus 2a allows the operation command transmission unit 27 to issue a notification of completion of the activating operation to the image projection apparatus 1 (step S04). Upon reception of the notification, the image projection apparatus 1 allows the operation command processing unit 13 to issue a notification of completion of connection to the terminal apparatus 2a (step S05). Thus, the connecting action for establishing the connection between the image projection apparatus 1 and the terminal apparatus 2a is completed in the image projection system S.

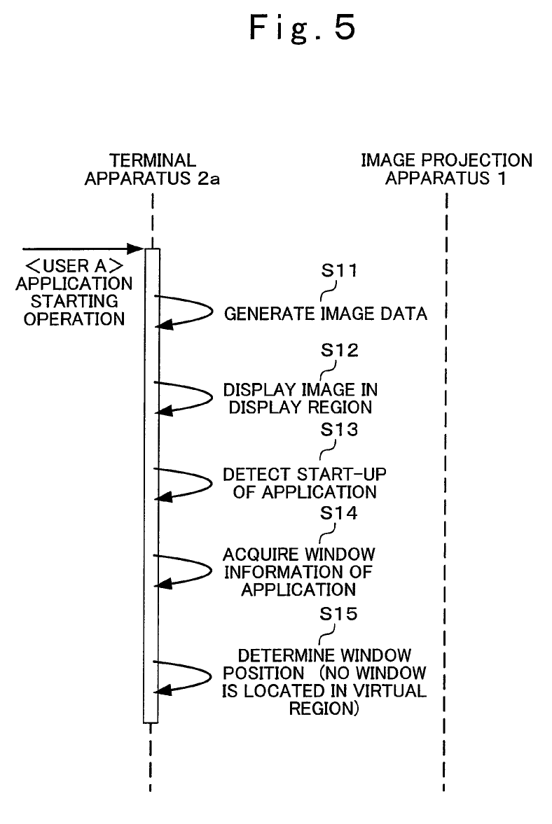

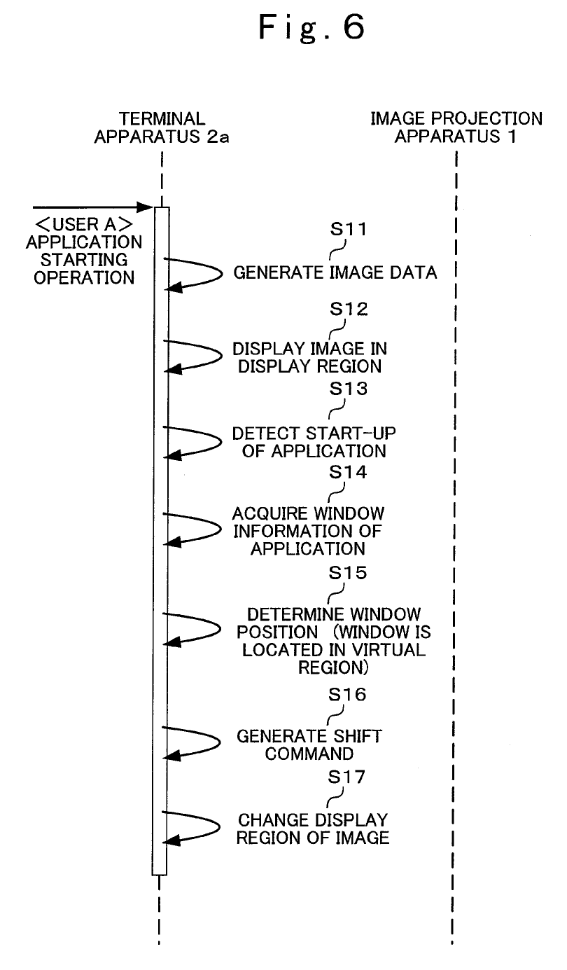

With reference to FIGS. 5 and 6, next, description will be given of an application starting action. FIGS. 5 and 6 show a sequence diagram of one example of the application starting action performed by the image projection system S in this embodiment. Specifically, this operation is performed by each of the terminal apparatuses 2a and 2b. Herein, the terminal apparatus 2a is described representatively.

As shown in FIG. 5, first, the user A conducts an executing operation for application programs of the terminal apparatus 2a, so that the terminal apparatus 2a executes an application program to be operated and generates image data in accordance with a data file of the application (step S11). Herein, the user A conducts the application program executing operation through the operation unit 26.

Herein, the data file denotes application retention data files prepared by execution of various applications, such as spreadsheet software and graphics preparation software, of the terminal apparatus 2, and is stored in the memory unit 20 of the terminal apparatus 2.

Moreover, the application programs function as the application control unit 32, the image generation unit 21 and the edit unit 23 in the terminal apparatus 2. When the user of the terminal apparatus 2 conducts a starting operation through the operation unit 26, the application control unit 32 starts up an application program. On the other hand, when the user of the terminal apparatus 2 conducts a terminating operation through the operation unit 26, the application control unit 32 terminates the application program. In other words, the application control unit 32 controls an application. Moreover, when the user of the terminal apparatus 2 conducts a data file executing operation through the operation unit 26, the application program functions as the image generation unit 21 to generate data of an image based on a data file stored in the memory unit 20 (e.g., an image 36a generated by the terminal apparatus 2a or an image 36b generated by the terminal apparatus 2b in FIG. 1). Further, when the user of the terminal apparatus 2 conducts a predetermined operation for the image data, which is generated by the image generation unit 21, through the operation unit 26 or the instruction unit 28, the application program functions as the edit unit 23 to edit the data file, based on the operation.

The terminal apparatus 2a allows the image generation unit 21 to generate the image data based on the data file, as described above, and then allows the display unit 24 to display an image based on the generated image data (step S12).

Next, the terminal apparatus 2a detects startup of an application which is started up newly (step S13), and allows the display control unit 29 to acquire window information of the application (step S14). Next, the terminal apparatus 2a allows the image position determination unit 30 to make window position determination for determining a position where a window is displayed (step S15). In a case where the window is not located in the virtual display region 45a, that is, in a case where the window is located in the common display region 40a, the terminal apparatus 2a completes the action without performing special actions thereafter.

As shown in FIG. 6, in the case where the window is located in the virtual display region 45a in step S15, the terminal apparatus 2a allows the image display position change unit 31 to generate a shift command for shifting the window to the common display region 40a (step S16). The terminal apparatus 2a allows the image display position change unit 31 to change a display region of the window image to the common display region 40, based on the shift command, and completes the action.

As described above, in a case where an application is started up and a display position of an image of image data generated based on the application is in the virtual display region 45a, the terminal apparatus 2a shifts the window from the virtual display region 45a to the common display region 40a.

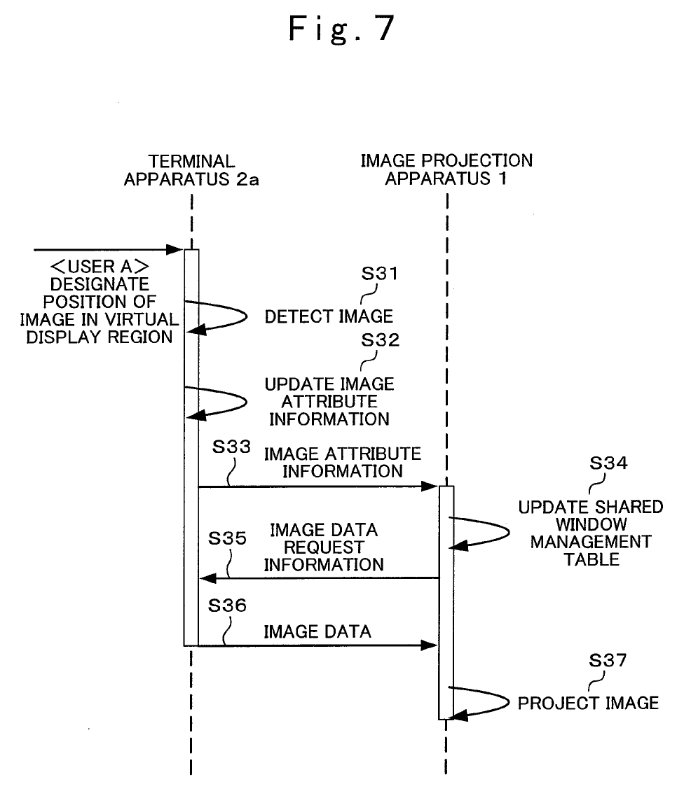

With reference to FIG. 7, next, description will be given of the projecting action. FIG. 7 shows a sequence diagram of one example of the projecting action performed by the image projection system S in this embodiment.

As shown in FIG. 7, when the image generated based on the application executed by the terminal apparatus 2a is located in the virtual display region 45a through the operation by the user A, the terminal apparatus 2a detects the image located in the virtual display region 45a (step S31) and updates image attribute information, based on a result of the detection (step S32). The image attribute information denotes information about an image located in the virtual display region 45, and contains identification information for identifying each image located in the virtual display region 45 (a window ID) as well as information about a position of the image, information about a size of the image and information indicating whether or not an image is generated based on an application started up newly (window information).

The user shifts the image from the common display region 40 to the virtual display region 45 in the display unit 24 as follows. For example, the user shifts the image to the virtual display region 45 through the operation unit 26 as will be described later. Alternatively, the user pushes down a predetermined button, which is provided at a predetermined position (e.g., a caption bar) of the image located in the common display region 40, through the operation unit 26, thereby shifting the image to the virtual display region 45.

When the image attribute information is updated, the terminal apparatus 2a transmits the updated image attribute information to the image projection apparatus 1 (step S33). Herein, the processes in steps S31 to S33 are executed by the predetermined region image transmission unit 22.

Next, upon reception of the image attribute information from each terminal apparatus 2, the image projection apparatus 1 allows the terminal connection management unit 15 to update information in a shared window management table (step S34). The shared window management table is a table for managing image attribute information about a plurality of pieces of image data acquired from the respective terminal apparatuses 2, and is stored in a predetermined region of the memory unit 14 of the image projection apparatus 1.

Next, the image projection apparatus 1 transmits image data request information to the terminal apparatus 2a, based on the information in the shared window management table (step S35). The image data request information is used for requesting, to the terminal apparatus 2a, image data of an image to be projected by the image projection unit 12 of the image projection apparatus 1 among the plurality of pieces of image data of the images located in the virtual display regions 45a. More specifically, when the image processing unit 11 of the image projection apparatus 1 superimposes a first image located in the virtual display region 45a on a second image located in the virtual display region 45a so as to combine the two images, the first image does not partially overlap with the second image. The image projection apparatus 1 requests to transmit image data corresponding to a portion of the first image which does not overlap with the second image (a portion which can be visually recognized as an image). The image projection apparatus 1 allows the image acquisition unit 10 to transmit the image data request information. Herein, the image data request information is also transmitted to another terminal apparatus (e.g., the terminal apparatus 2b ) connected to the image projection apparatus 1 as in the same manner.

Based on the image data request information, the terminal apparatus 2a partially or entirely transmits the image data of the image located in the virtual display region 45a to the image projection apparatus 1 via the communication path 3 (step S36). Herein, the terminal apparatus 2a allows the predetermined region image transmission unit 22 to transmit the image data.

Finally, upon reception of the plurality of pieces of image data from the respective terminal apparatuses 2, the image projection apparatus 1 combines the plurality of pieces of image data, based on the information in the shared window management table to generate composite image data, and then allows the image projection unit 12 to project an image based on the composite image data (hereinafter, referred to as “composite image” in some instances) (step S37). Herein, the image projection apparatus 1 allows the image processing unit 11 to combine the plurality of pieces of image data acquired from the respective terminal apparatuses 2.

As shown in FIG. 1, more specifically, in the case where the image 36a is located in the virtual display region 45a of the terminal apparatus 2a and the image 36b is located in the virtual display region 45b of the terminal apparatus 2b, the image projection apparatus 1 allows the image acquisition unit 10 to acquire the image data of the image 36a acquired from the terminal apparatus 2a and the image data of the image 36b acquired from the terminal apparatus 2b, allows the image processing unit 11 to combine the plurality of pieces of image data to generate the composite image data, and allows the image projection unit 12 to project the composite image based on the composite image data. Herein, in a case where an image is located over the virtual display region 45a and the common display region 40a other than the virtual display region 45a, the image projection apparatus 1 acquires only image data corresponding to a portion of the image located in the virtual display region 45a.

As described above, the image processing unit 11 of the image projection apparatus 1 prepares the image based on the composite image data and the image projection unit 12 of the image projection apparatus 1 projects the image onto the large screen. This configuration eliminates a necessity of transmitting the image data of the composite image to each terminal apparatus 2 and, therefore, can lighten a load to be imposed on the communication path 3. As a result, even when many terminal apparatuses are connected to the image projection apparatus, users of the terminal apparatuses can smoothly conduct sharing of information.

Moreover, the terminal apparatus 2 in this embodiment does not entirely transmit the image data of the image located in the virtual display region 45. In other words, when the image processing unit 11 of the image projection apparatus 1 combines the image data of the terminal apparatus 2 and image data from another terminal apparatus 2, the terminal apparatus 2 does not transmit image data corresponding to a portion of the image which overlaps with the image data from another terminal apparatus 2.

As described above, when the image processing unit 11 of the image projection apparatus 1 combines a plurality of pieces of image data among the plurality of pieces of image data of the images located in the virtual display regions 45, the predetermined region image transmission unit 22 of the terminal apparatus 2 does not transmit to the image projection apparatus 1 the image data corresponding to a portion of the image which is not projected by the image projection unit 12. Therefore, extra image data is not transmitted to the image projection apparatus 1, and image data to be transmitted can be made small in size. As a result, this configuration can lighten a load to be imposed on the communication path 3.

As described above, in the image projection system S in this embodiment, the predetermined region image transmission unit 22 of the terminal apparatus 2 transmits the image attribute information, which is information about the image data, to the image projection apparatus 1 via the communication path 3, the image acquisition unit 10 of the image projection apparatus 1 acquires the image attribute information via the communication path 3, the image processing unit 11 of the image projection apparatus 1 combines the plurality of pieces of image data of the images located in the virtual display regions 45 of the respective terminal apparatuses 2, based on the image attribute information. With this configuration, the image projection apparatus 1 can combine the plurality of pieces of image data, based on the image attribute information. Therefore, in a case where the image attribute information contains, for example, an image display position and an image size, the image projection apparatus 1 can project and display the image which is arranged based on the information.

In this embodiment, each time the image generation unit 21 generates image data of an image located in the virtual display region 45 based on an edited data file, the control unit of the terminal apparatus 2 transmits the image data of the image located in the virtual display region 45 to the image projection apparatus 1.

More specifically, each time the image attribute information is updated in step S32, the terminal apparatus 2 transmits the updated image attribute information to the image projection apparatus 1. With this configuration, the process from the predetermined operation conducted by the user of the terminal apparatus 2 to the transmission of the image data to the image projection apparatus 1 in step S36 can be executed smoothly. In other words, the image projected by the image projection apparatus 1 can be updated in real time. Therefore, the plurality of users of the terminal apparatuses 2 can smoothly conduct the sharing of information and the collaborative operations.

In this embodiment, moreover, the terminal apparatus 2 includes the virtual display region 45 which is provided separately from the common display region 40 of the display unit 24 and serves as the predetermined display region. This configuration allows the plurality of users of the terminal apparatuses 2 to smoothly conduct the sharing of information and the collaborative operations. For example, the user of the terminal apparatus 2 can distinctly distinguish the predetermined display region from the region other than the predetermined display region and, therefore, can prevent an unintended image from being projected and displayed. Moreover, the image located in the common display region 40 of the display unit 24 is not projected and displayed by the image projection apparatus 1. Therefore, the common display region 40 of the display unit 24 can be utilized as a working space only for the user of the terminal apparatus 2.

Herein, the image projection system S in this embodiment allows edit of an arbitrary data file in accordance with a request from the terminal apparatus 2. In this embodiment, more specifically, upon acquisition from another terminal apparatus an image operation command for operating any one of images projected by the image projection unit 12, the image projection apparatus 1 allows the operation command processing unit 13 to transmit the image transmission information to the terminal apparatus 2 which has transmitted image data of the image to be operated based on the image operation command. Upon reception of the image operation command, the terminal apparatus 2 allows the edit unit 23 to edit a data file in accordance with the image operation command.

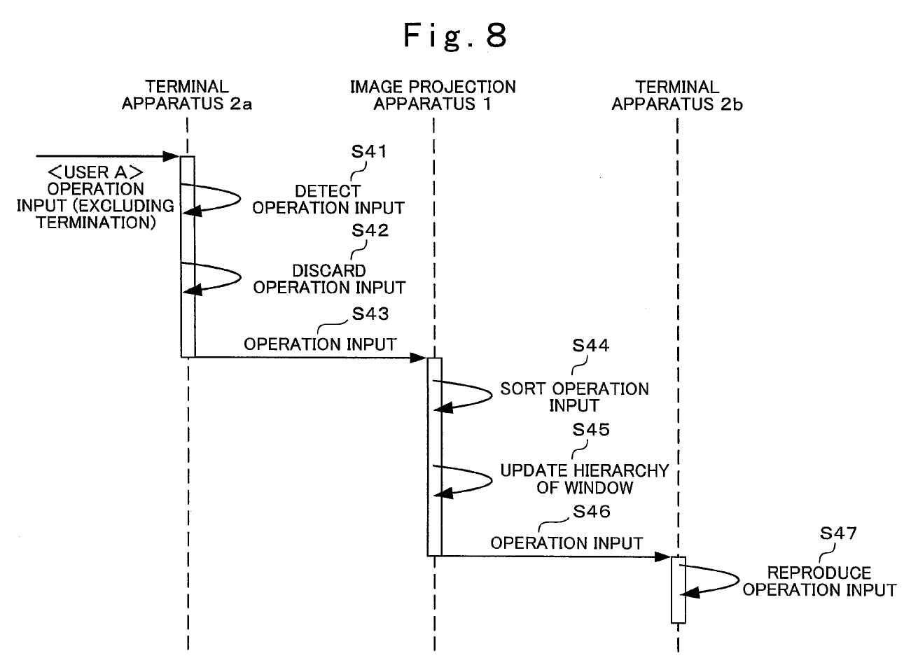

With reference to FIG. 8, hereinafter, description will be given of the editing action in more detail. FIG. 8 shows a sequence diagram of one example of the editing action performed by the image projection system S in this embodiment.

As shown in FIG. 8, the user A of the terminal apparatus 2a conducts a predetermined operation input (e.g., shift of an image) for the image located in the virtual display region 45b of the terminal apparatus 2b among the images projected by the image projection apparatus 1, so that the terminal apparatus 2a acquires an operation input based on the operation (step S41) Herein, the user A conducts the operation for the image, which is projected by the image projection apparatus 1 and is located in the virtual display region 45b of the terminal apparatus 2b, through the operation unit 26 or the instruction unit 28.

Next, the terminal apparatus 2a discards the operation input in order to prevent the operation conducted by the user A from being executed by the terminal apparatus 2a (step S42), and transmits the operation input to the image projection apparatus 1 via the communication path 3 (step S43). Herein, the terminal apparatus 2 allows the operation command transmission unit 27 to discard the operation input and to transmit the operation input.

Next, upon reception of the operation input from the terminal apparatus 2a, the image projection apparatus 1 allows the operation command processing unit 13 to execute a process of sorting the operation input for each terminal apparatus 2 (step S44). Herein, the operation input is sorted so as to be transmitted to the terminal apparatus 2b

Moreover, the image projection apparatus 1 updates a hierarchical level allocated to the image located in the virtual display region 45 of each terminal apparatus 2, based on the received operation input and the window information (the image attribute information) acquired by the image acquisition unit 10 (step S45). More specifically, the image projection apparatus 1 determines an operated image, based on the operation input and the window information, set at an uppermost layer the hierarchical level of the image managed by the shared window management table, and lowers the hierarchical level of another image successively. Herein, the image projection apparatus 1 allows the image processing unit 11 to update the hierarchical level.

In this embodiment, as described above, the image processing unit 11 of the image projection apparatus 1 allocates different hierarchical levels to the plurality of pieces of image data of the images located in the virtual image display regions 45 of the respective terminal apparatuses 2, and superimposes the plurality of pieces of image data on one another in order of hierarchical level to combine the plurality of pieces of image data.

As shown in FIG. 1, the image processing unit 11 of the image projection apparatus 1 allocates the hierarchical levels to the image 36a located in the virtual display region 45a of the terminal apparatus 2a and the image 36b located in the virtual display region 45b of the terminal apparatus 2b, superimposes the images 36a and 36b on each other in increasing order of hierarchical level to combine the two pieces of image data, and projects the image based on the composite image data (the composite image).

With this configuration, the image processing unit 11 of the image projection apparatus 1 superimposes the plurality of pieces of image data of the images located in the virtual display regions 45 of the respective terminal apparatuses 2 on one another in order of hierarchical level to combine the plurality of pieces of image data; therefore, the projected image can be displayed clearly without a necessity for the image projection apparatus 1 to be made high in resolution and angle of view. As a result, the plurality of users of the terminal apparatuses 2 can smoothly conduct the sharing of information and the collaborative operations.

Next, the image projection apparatus 1 allows the operation command processing unit 13 to transmit the image operation command received from the terminal apparatus 2a in step S43 to the terminal apparatus 2b via the communication path 3 (step S46). Upon reception of the image operation command, the terminal apparatus 2b reproduces the operation input based on the image operation command (step S47) In accordance with the reproduced operation input, the application functions as the edit unit 23 to edit the executed data file.

In the image projection system S in this embodiment, as described above, the image projection apparatus 1 acquires the image operation command for operating the predetermined image among the images projected by the image projection unit 12, and then transmits the image operation command to the terminal apparatus 2, which has transmitted the image data of the image to be operated based on this image operation command, via the communication path 3 Upon reception of the image operation command from the image projection apparatus 1 via the communication path 3, the terminal apparatus 2 edits the data file in accordance with the image operation command. Therefore, the user of the terminal apparatus 2 can edit not only images held by his/her terminal apparatus 2, but also images transmitted from another terminal apparatus 2. Thus, the plurality of users of the terminal apparatuses 2 can smoothly conduct the collaborative operations.

In the image projection system S in this embodiment, the instruction unit 28 of the terminal apparatus 2 points an image projected by the image projection apparatus 1. When the instruction unit 28 is subjected to a predetermined operation, the operation command transmission unit 27 transmits an image pointing command corresponding to this operation to the image projection apparatus 1. Upon reception of the image pointing command from the terminal apparatus 2, the image processing unit 11 of the image projection apparatus 1 combines a pointer image at a position based on the image pointing command and the plurality of pieces of image data of the images located in the virtual display regions 45 of the respective terminal apparatuses 2.

As shown in FIG. 1, examples of the image projected by the image projection apparatus 1 include pointer images P1 and P2 based on the image pointing command, in addition to the composite image based on the plurality of pieces of image data acquired from the respective terminal apparatuses 2.

This configuration allows the user of the terminal apparatus 2 to grasp a pointed position in the region projected by the image projection apparatus 1.

### 2. Specific Configuration of Image Projection System

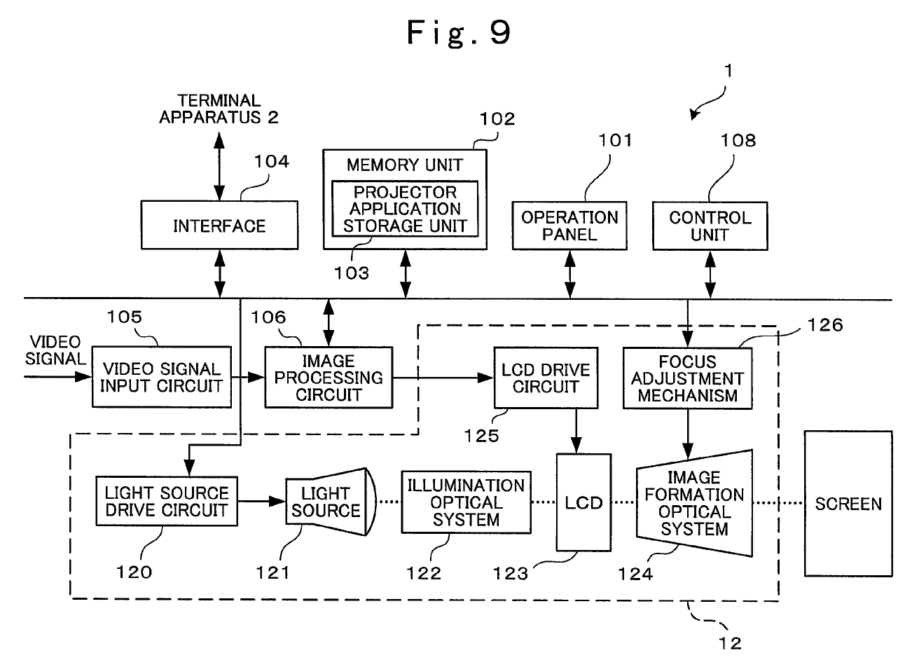

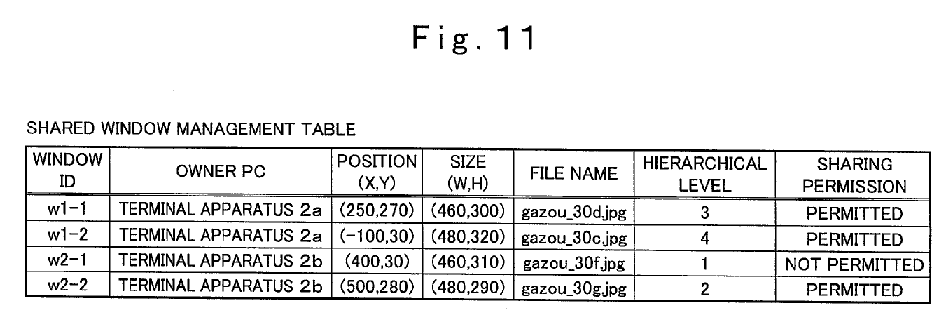

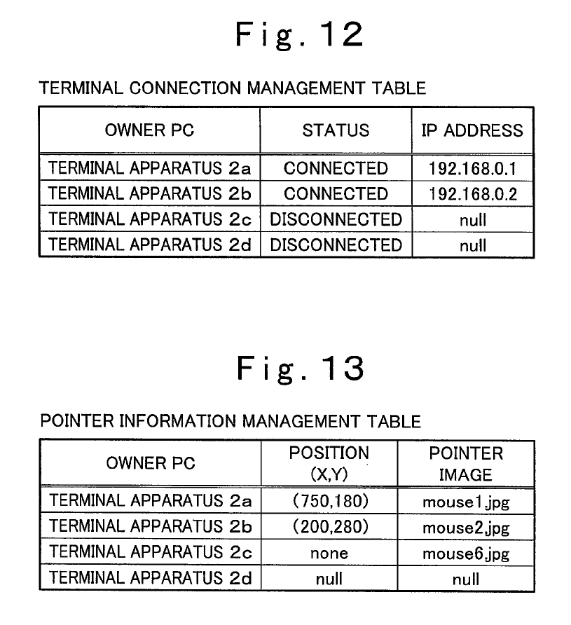

(With Regard to Configuration of Image Projection Apparatus 1) Next, description will be given of a configuration of the image projection apparatus 1. FIG. 9 shows the configuration of the image projection apparatus 1 in this embodiment. FIG. 11 shows one example of a shared window management table stored in the image projection apparatus 1 in this embodiment. FIG. 12 shows one example of a terminal connection management table stored in the image projection apparatus 1 in this embodiment. FIG. 13 shows one example of a pointer information management table stored in the image projection apparatus 1 in this embodiment.

As shown in FIG. 9, the image projection apparatus 1 includes an operation panel 101 that performs various operations, a memory unit 102 that corresponds to a nonvolatile memory for holding setting information and a data file, an interface 104 that establishes communications with the terminal apparatus 2, a video signal input circuit 105 that receives an external video signal, an image processing circuit 106 that executes a predetermined process for the video signal received through the video signal input circuit 105 and image data acquired through the interface 104, the image projection unit 12 that projects an image based on an image signal outputted from the image processing circuit 106, and a control unit 108 that controls the entire image projection apparatus 1. These units are incorporated in a housing. In particular, the image projection unit 12 projects an image based on image data prepared by combining the plurality of pieces of image data of the images located in the virtual display regions 45 of the respective terminal apparatuses 2.

In the image projection apparatus 1, when the user operates the operation panel 101, the control unit 108 performs control in accordance with details of the operation.

Memory unit 102 is, for example, a hard disc drive or a flash memory and includes a projector application storage unit 103 in the image projection apparatus 1. The projector application storage unit 103 stores information of resolution set by the image projection apparatus 1, image data of a pointer image, and image data of an image located in the virtual display region 45 of each terminal apparatus 2. In addition, the projector application storage unit 103 stores a shared window management table for managing position information of the image and size information of the image, a connection information management table for managing a connection status of the terminal apparatus 2 connected to the image projection apparatus 1, a pointer information management table for storing pointer position information, and the like.

The interface 104 is a USB interface capable of establishing communications with an external apparatus, and is used by the control unit 108 in order to acquire image data, an image operation command and the like from the terminal apparatus 2 and to establish communications with an external computer apparatus. In place of the USB interface, herein, a wireless or wired LAN interface may be used as the interface 104.

The video signal input circuit 105 receives video signals such as a composite video signal (e.g., an NTSC video signal) and a component video signal (e.g., an RGB signal).

Based on the control by the control unit 108, the image processing circuit 106 combines the video signals received at the video signal input circuit 105 or the plurality of pieces of image data acquired through the interface 104 to generate image signals. The image signals are inputted to the image projection unit 12.

The image projection unit 12 includes a light source drive circuit 120, a light source 121, an illumination optical system 122, a transparent liquid crystal panel 123 (hereinafter, described as “LCD 123”), an image formation optical system 124, an LCD drive circuit 125, and a focus adjustment mechanism 126.

The light source 121 is, for example, a lamp and emits light based on a signal outputted from the light source drive circuit 120 controlled by the control unit 108. The light emitted from the light source 121 is directed as illumination light to the LCD 123 through the illumination optical system 122.

The LCD 123 is driven by the LCD drive circuit 125, and displays video on a display face thereof. The video displayed as described above is emitted as light from the LCD 123 by the illumination light from the illumination optical system 122. Subsequently, this outgoing light passes the image formation optical system 124 and an opening for projection (not shown) in the housing, and then is projected onto a screen (a projection face). Thus, the image displayed on the LCD 123 is projected onto the screen. Herein, the focus adjustment mechanism 126 can adjust a focus of the image projected on the screen.

The control unit 108 includes a CPU (Central Processing Unit), a ROM (Read Only Memory), a RAM (Random Access Memory) and the like. When the CPU reads and executes programs stored previously in the ROM, the image projection apparatus 1 functions as the image acquisition unit 10 that acquires a plurality of pieces of image data of images located in the virtual display regions 45 (the predetermined display regions) of the terminal apparatuses 2 via the communication path 3, the image processing unit 11 that combines the plurality of pieces of image data of the images located in the virtual display regions 45 of the terminal apparatuses 2, the operation command processing unit 13 that acquires an image operation command for operating any one of images projected by the image projection unit 12 and then transmits the image operation command to the terminal apparatus 2 which has transmitted image data of the image to be operated based on the image operation command, the terminal connection management unit 15 that manages connection with the terminal apparatus 2, and the like.

The control unit 108 functions as the image acquisition unit 10 to acquire the image data of the image located in the virtual display region 45 of the terminal apparatus 2 or the image operation command, from the terminal apparatus 2 via the interface 104. Herein, the image operation command may be acquired from a remote controller (not shown).

Moreover, the control unit 108 functions as the image processing unit 11 together with the image processing circuit 106 to combine the plurality of pieces of image data of the images located in the virtual display regions 45 of the respective terminal apparatuses. That is, the image processing unit 11 has an image combining unit (not shown) that executes the combining process described above. The image processing unit 11 executes the image data combining process, based on the shared window management table and the connection information management table each stored in the memory unit 102. The image processing unit 11 functions as the image processing unit together with the image processing circuit 106 to depict an image for projection, based on the composite image data. That is, the image processing unit 11 has an image depicting unit (not shown) that executes the depicting process described above.

Moreover, the control unit 108 functions as the terminal connection management unit 15 to manage a shared window. That is, the terminal connection management unit 15 has a shared window management unit (not shown) that executes the managing process described above.

With reference to FIG. 11, next, description will be given of the shared window management table.

As shown in FIG. 11, the shared window management table stores a name of the terminal apparatus 2 (an owner PC) which has transmitted an image located in the virtual display region 45 thereof, information about a display position and a size of the image, information about a file name of image data, information about an order (a hierarchical level) of superimposition of a plurality of pieces of image data to be combined by the image processing unit 11, and information for determining whether or not a relevant window is a sharing permitted window. Herein, each information is correlated with information for identifying the image (a window ID).

The information about the display position and the size of the image located in the virtual display region 45 of each terminal apparatus 2 is represented by coordinates specified by a projection region 60 projected by the image projection apparatus 1. That is, the image projection apparatus 1 in this embodiment specifies a vertical direction of the projection region 60 as an X direction, a horizontal direction of the projection region 60 as a Y direction, and an upper left apex of the projection region 60 as an origin point. The position information of the image is information of coordinates of an upper left apex of each image located in the virtual display region 45, and the size information of the image is information represented by expressing a width (W) and a height (H) of the image in a numeric value on a coordinate, respectively. Use of the position information and the size information allows determination of a position and a size of the image, which is located in the virtual display region 45, to be projected on the projection region 60 projected by the image projection apparatus 1.

Moreover, the name of the terminal apparatus 2 (the owner PC), which has transmitted the image data, is correlated with the terminal connection management table shown in FIG. 12. As shown in FIG. 12, the terminal connection management table stores names of the terminal apparatuses 2 connected to the image projection apparatus 1. Herein, each name is correlated with a connection status (i.e., whether or not the relevant terminal apparatus 2 is connected to the image projection apparatus 1) and an IP address allocated to each terminal apparatus 2.

Moreover, the control unit 108 functions as the image processing unit 11 to combine a pointer image at a position based on an image pointing command transmitted from the operation command transmission unit 27 of the terminal apparatus 2 and the plurality of pieces of image data of the images located in the virtual display regions 45 of the respective terminal apparatuses 2. Herein, the pointer image combining process is executed based on information in the pointer information management table.

As shown in FIG. 13, the pointer information management table stores position information of a pointer image in the projection region 60 projected by the image projection apparatus 1, and a file name of a pointer image allocated to the terminal apparatus 2 connected to the image projection apparatus 1. Herein, the information is correlated with the name of the terminal apparatus 2. With regard to the terminal apparatus which is not connected to the image projection apparatus 1, “null” is set as position information and a name of a pointer image. With regard to the terminal apparatus which is connected to the image projection apparatus 1 but has a pointer image located out of the virtual display region 45, “none” is set as position information of the pointer image.

In this embodiment, different hierarchical levels are allocated to the plurality of pieces of image data of the images located in the virtual display regions 45 of the respective terminal apparatuses 2, and the plurality of pieces of image data are combined so as to be superimposed on one another in order of hierarchical level. In order to combine the plurality of pieces of image data of the images located in the virtual display regions 45 of the respective terminal apparatuses 2, the control unit 108 refers to the information of the hierarchical level, which is stored in the shared window management table, and generates image data of an image as if images are superimposed on one another in decreasing order of hierarchical level.

Moreover, the control unit 108 functions as the operation command processing unit 13 to acquire the image operation command from the terminal apparatus 2. That is, the operation command processing unit 13 has an image operation command acquisition unit (not shown) that acquires an image operation command for operating a predetermined image among projected images.

Moreover, the control unit 108 functions as the operation command processing unit 13 to determine whether or not an image operation command is a command concerning termination of an application, that is, to determine a type of an image operation command. That is, the operation command processing unit 13 has an image operation command determination unit (not shown) that determines whether or not an acquired image operation command is an image termination command for terminating display of an image.

Moreover, the control unit 108 functions as the operation command processing unit 13 to determine a target terminal apparatus 2 of the image operation command, based on the image operation command from the terminal apparatus 2, and to sort a transmission destination of the image operation command. That is, the operation command processing unit 13 has an operation input sorting unit (not shown) that executes the sorting process described above.

Moreover, the control unit 108 functions as the operation command processing unit 13 together with the interface 104 to acquire an image operation command for operating any one of the images projected by the image projection unit 12 and, then, to transmit the image operation command to the terminal apparatus 2 which has transmitted image data of the image to be operated based on the image operation command. That is, the operation command processing unit 13 has an operation command processing unit (not shown) that, in a case where an image operation command is determined as an image termination command for terminating display of an image, transmits an image termination command for terminating display of an image to a terminal apparatus, which has transmitted the image data of the image to be operated based on the image operation command, via the communication path 3.

In this embodiment, upon transmission of the image operation command to the terminal apparatus 2, the image data of the image to be operated by the image operation command and the terminal apparatus 2 to which the image operation command must be transmitted are determined based on the image attribute information acquired by the image acquisition unit 10.

This configuration allows elimination of a necessity of additionally requesting information for determining image data of an image to be operated to each terminal apparatus 2 for each operation therefor, and can lighten a load to be imposed on the communication path 3.

### (With Regard to Configuration of Terminal Apparatus 2)

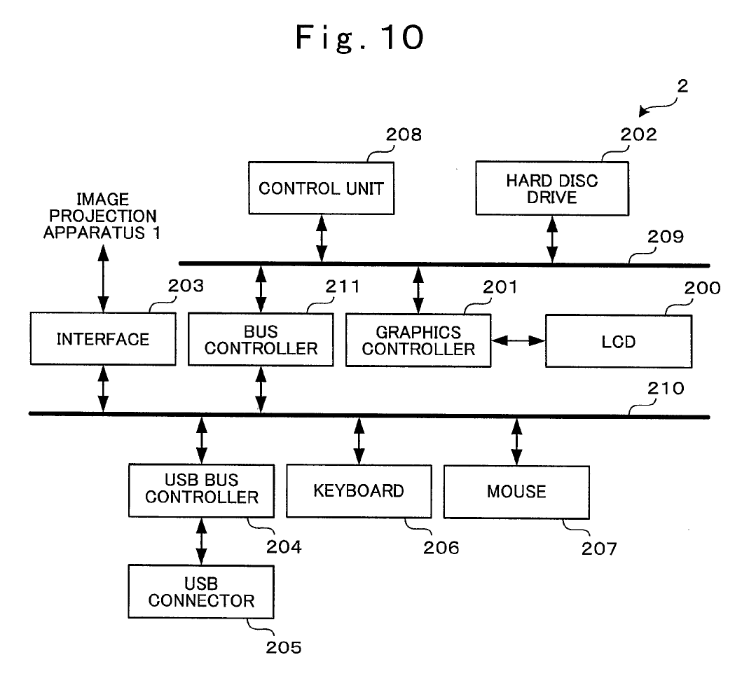

Next, description will be given of a configuration of the terminal apparatus 2. FIG. 10 shows the configuration of the terminal apparatus 2 in this embodiment.

The terminal apparatus 2 in this embodiment may be a typical personal computer or a dedicated terminal. As shown in FIG. 10, the terminal apparatus 2 includes an LCD 200 that serves as a display unit, a graphics controller 201 that drives the LCD 200, a hard disc drive 202 that stores various kinds of data, an interface 203 that establishes communications with the image projection apparatus 1 via the communication path 3, a USB bus controller 204 that exchanges data with a USB device, a USB connector 205 that serves as a connection port to be connected to the USB bus controller 204, a keyboard 206 and a mouse 207 (corresponding to the instruction unit and the operation unit) that allow the user to input predetermined information, and a control unit 208 that controls the entire terminal apparatus 2. These elements are mutually connected to one another through a first bus 209 and a second bus 210. It is to be noted that a bus controller 211 shown in FIG. 10 is a bus controller that allows the first data bus 209 and the second data bus 210 to exchange data with each other.

The hard disc drive 202 functions as the memory unit 20, and stores an operating system (OS) program for the terminal apparatus 2 and various application programs such as document preparation software, presentation software, spreadsheet software and graphics preparation software. In addition, the hard disc drive 202 also stores data files created by these application programs. In addition to the application programs described above, the hard disc drive 202 also stores an image sharing program serving as a processing program for the image projection system S in this embodiment. Moreover, the memory unit 20 has an image position storage unit that, in a case where a generated application is terminated, stores a display position of a window (an image) at the time of termination of the application.

For example, the image sharing program may be downloaded from a server (not shown) connected to the communication path 3 into the hard disc drive 202 of the control unit 208 via the interface 203. Alternatively, the image sharing program may be recorded in a recording medium such as a CD-ROM, and then may be loaded into the hard disc drive 202 of the control unit 208 through a recording medium drive (not shown).

The interface 203 is a USB interface capable of establishing communications with an external apparatus, and is used by the control unit 208 in order to acquire image data, an image operation command and the like from the terminal apparatus 2 or to establish communications with the external apparatus. In place of the USB interface, a wireless or wired LAN interface may be used as the interface 203.

The control unit 208 includes a CPU (Central Processing Unit), a ROM (Read Only Memory), a RAM (Random Access Memory) and the like. When the CPU reads and executes the image sharing program stored in the hard disc drive 202, the terminal apparatus 2 functions as the predetermined region image transmission unit 22, the virtual display region setting unit 25, the operation command transmission unit 27, the image position determination unit 30 and the image display position change unit 31.

Moreover, when the CPU reads and executes the various application programs stored in the hard disc drive 202, the control unit 208 functions as the image generation unit 21, the edit unit 23 and the display control unit 29.

The CPU of the control unit 208 executes the various application programs stored in the hard disc drive 202 to function as the image generation unit 21, and generates image data based on a data file of the application. The graphics controller 201 allows the LCD 200 serving as a display unit to display an image based on the generated image data.

The control unit 208 functions as the predetermined region image transmission unit 22 together with the interface 203. As a result, in a case where a position of an image based on image data generated by the image generation unit 21 is in the virtual display region 45, the control unit 208 partially or entirely transmits the image data of the image to the image projection apparatus 1 via the communication path 3. Herein, the predetermined display region in this embodiment is the virtual display region 45 set so as to adjoin to the common display region 40 of the display unit 24. The virtual display region 45 is set in such a manner that the CPU of the control unit 208 executes the image sharing program stored in the hard disc drive 202 to function as the virtual display region setting unit 25.

In the image projection system S in this embodiment, each time the image generation unit 21 generates the image data of the image located in the virtual display region 45 based on the edited data file, the predetermined region image transmission unit 22 transmits the image data to the image projection apparatus 1.

With this configuration, the image which is projected by the image projection apparatus 1 can be updated in real time, so that the plurality of users of the terminal apparatuses 2 can smoothly conduct the sharing of information and the collaborative operations.

In order to transmit the image data, BMP (Bit Map) data obtained by capturing the image located in the virtual display region 45 is converted into JPEG (Joint Photographic Experts Group) data. As described above, the image data to be transmitted to the image projection apparatus 1 is compressed, so that a load to be imposed on the communication path 3 can be lightened.

Moreover, the control unit 208 functions as the edit unit 23. As a result, upon reception of an image operation command from the image projection apparatus 1 via the communication path 3, the control unit 208 acquires the image operation command, reproduces an operation input from the image operation command, edits a data file in accordance with the operation input, and discards the image operation command. Herein, the control unit 208 receives the image operation command through the interface 203. The edit unit 23 described above has an operation input acquisition unit that acquires the image operation command, an operation input reproduction unit that reproduces the image operation command, and an operation input discarding unit that discards the image operation command.

Moreover, the control unit 208 functions as the operation command transmission unit 27 together with the interface 203. As a result, in a case where a pointer is located in the virtual display region 45, when a predetermined operation/instruction is inputted through the keyboard 206 or the mouse 207, the control unit 208 transmits an image operation command corresponding to the operation/instruction to the image projection apparatus 1. Herein, the control unit 208 discards operation input information or instruction information, and then transmits the image operation command to the image projection apparatus 1, in order to prevent the terminal apparatus 2 from executing the operation/instruction. In particular, the operation command transmission unit 27 has a generation information transmission unit (not shown) that, when the image generation unit 21 generates an image, transmits generation information about generation of the image to the image projection apparatus 1 via the communication path 3, and a termination information transmission unit (not shown) that, when display of the image is terminated, transmits termination information about termination of the display to the image projection apparatus 1 via the communication path 3. Herein, the “operation” denotes a command for editing a data file executed based on an application of the terminal apparatus or another terminal apparatus while the “instruction” denotes a command for displaying or shifting a pointer image for pointing an image projected by the image projection apparatus 1.

As described above, the keyboard 206 or the mouse 207 is used as the operation unit, thereby operating or editing an image which is projected by the image projection apparatus 1 and is located in the virtual display region 45 of another terminal apparatus 2. Moreover, the mouse 207 is used as the instruction unit, thereby allowing the user of the terminal apparatus 2 to grasp a pointed position in the region projected by the image projection apparatus 1. Further, the image is operated or instructed in such a manner that an image operation command is transmitted to the terminal apparatus which has transmitted image data of the image to be operated. Therefore, the image can be operated without imposing a large load on the communication path 3.

Moreover, the control unit 208 functions as the display control unit 29 together with the graphics controller 201 to control display of an image based on generated image data and to control termination of the display.

Moreover, the control unit 208 functions as the image position determination unit 30. As a result, when display of an image generated based on an application is terminated in the predetermined display region and, then, the image based on the application is generated again, the control unit 208 determines whether or not a position of the stored image is in the virtual display region 45, thereby determining whether or not the position of the image of which the display is terminated is in the virtual display region 45.

Moreover, the control unit 208 functions as the image display position change unit 31. As a result, on conditions that display of an image generated based on an application is terminated in the predetermined display region and the image based on the application is generated again, the control unit 208 updates a position of the stored image as the common display region 40 rather than the virtual display region 45, thereby changing the display position of the image from the virtual display region 45 to the common display region 40.

### (With Regard to Specific Action in Image Projection Apparatus)

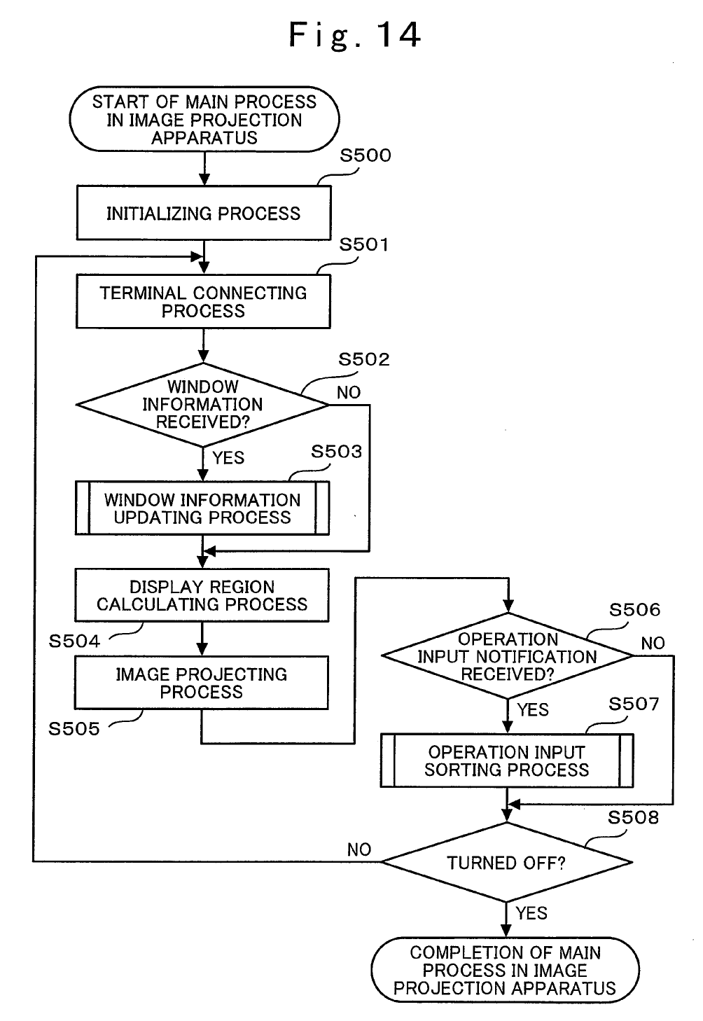

With reference to FIGS. 14 to 21, next, description will be given of one example of a specific action performed by the image projection apparatus 1. FIG. 14 shows a flowchart of a main process executed by the image projection apparatus 1 in this embodiment.

### (Main Process in Image Projection Apparatus)

As shown in FIG. 14, when a user pushes down a power supply switch (not shown) of the image projection apparatus 1, the control unit 108 of the image projection apparatus 1 executes an initializing process (step S500). Next, the control unit 108 executes a connecting process (step S501). This connecting process is executed for connecting the image projection apparatus 1 to the terminal apparatus 2 via the communication path 3.

Next, the control unit 108 determines whether or not to receive window information (image attribute information) from the terminal apparatus 2 (step S502). In this process, if the control unit 108 receives the window information from the terminal apparatus 2 (Yes in step S502), then, the control unit 108 executes a window information updating process (step S503). This window information updating process is executed for updating the contents of the shared window management table in accordance with information transmitted from the terminal apparatus 2. Upon completion of the window information updating process in step S503, the control unit 108 executes a process in step S504. On the other hand, if the control unit 108 receives no window information from the terminal apparatus 2 (No in step S502), then, the control unit 108 executes the process in step S504 without executing the process in step S503.

In step S504, the control unit 108 executes the display region calculating process. This display region calculating process is executed for calculating a display region of each image to be projected by the image projection apparatus 1 in the projection region 60.

Upon completion of the process in step S504, the control unit 108 executes an image projecting process (step S505). This image projecting process is executed for combining a plurality of pieces of image data acquired from the plurality of terminal apparatuses 2 and pointer images, and projecting a composite image. In other words, the control unit 108 acquires the plurality of pieces of image data of the images located in the virtual display regions 45 of the respective terminal apparatuses 2 via the communication path 3, combines the plurality of pieces of image data to generate the composite image data, and projects the image based on the composite image data.

Next, the control unit 108 determines whether or not to receive a notification of an operation input (step S506). In this process, if the control unit 108 receives the operation input notification (the image operation command) from the terminal apparatus 2 (Yes in step S506), then, the control unit 108 executes an operation command sorting process (step S507) This operation command sorting process is executed for transmitting the operation input to the terminal apparatus 2 which has transmitted image data of an image to be operated based on the operation input received from the terminal apparatus 2.

On the other hand, if the control unit 108 completes the process in step S507 or if the control unit 108 receives no operation input notification from the terminal apparatus 2 in step S506 (No in step S506), then, the control unit 108 determines whether or not the power is turned off (step S508). If the power is not turned off (No in step S508), the control unit 108 executes the process in step S501. On the other hand, if the power is turned off (Yes in step S508), the control unit 108 completes the main process. In other words, the control unit 108 acquires an image operation command for operating a predetermined image among projected images, and determines whether or not the acquired image operation command is an image termination command for terminating display of the image, that is, determines a type of the image operation command.

### (With Regard to Specific Action in Terminal Apparatus)

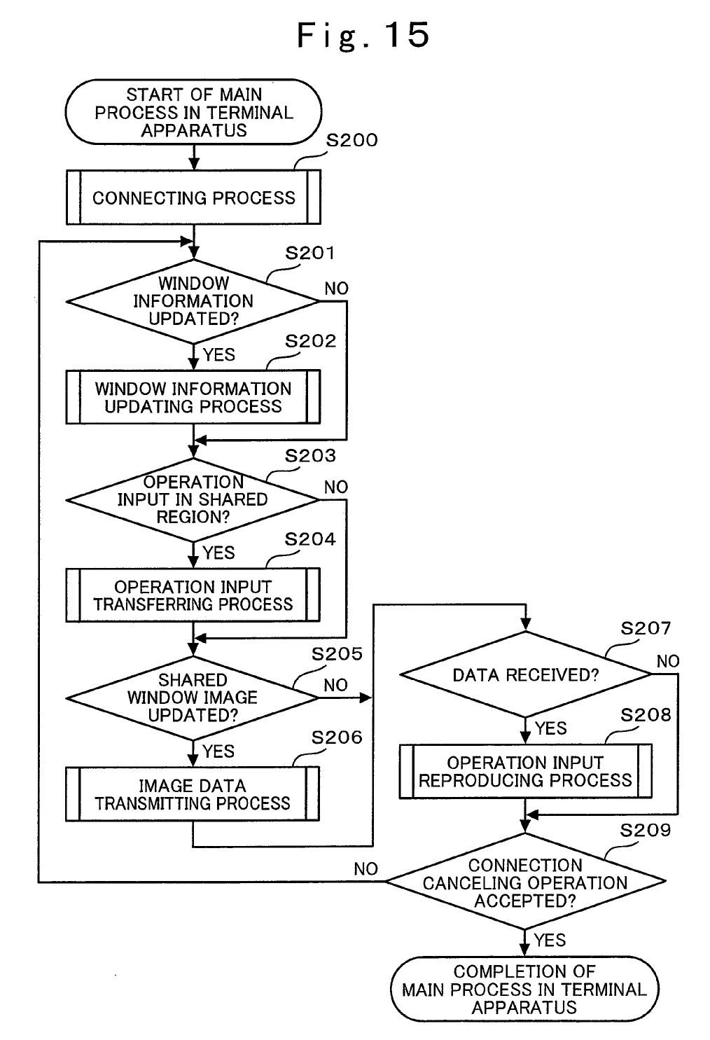

With reference to FIGS. 15 to 21, next, description will be given of one example of a specific action in the terminal apparatus 2. FIG. 15 is a flowchart of a main process executed by the terminal apparatus 2 in this embodiment.

### (Main Process in Terminal Apparatus)

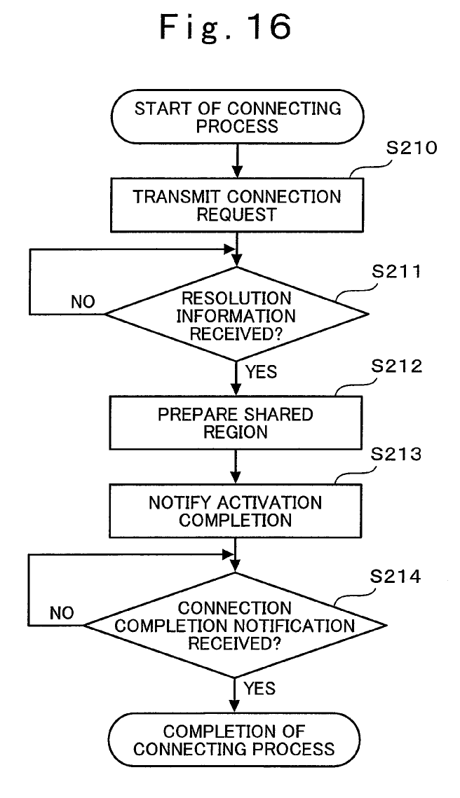

As shown in FIG. 15, when the user pushes down a power supply switch (not shown) of the terminal apparatus 2, the control unit 208 of terminal apparatus 2 executes a connecting process (step S200). This connecting process is executed for connecting the terminal apparatus 2 to the image projection apparatus 1 via the communication path 3. This process is equal to processes in steps S210 to S214 shown in FIG. 16 and will be described later.

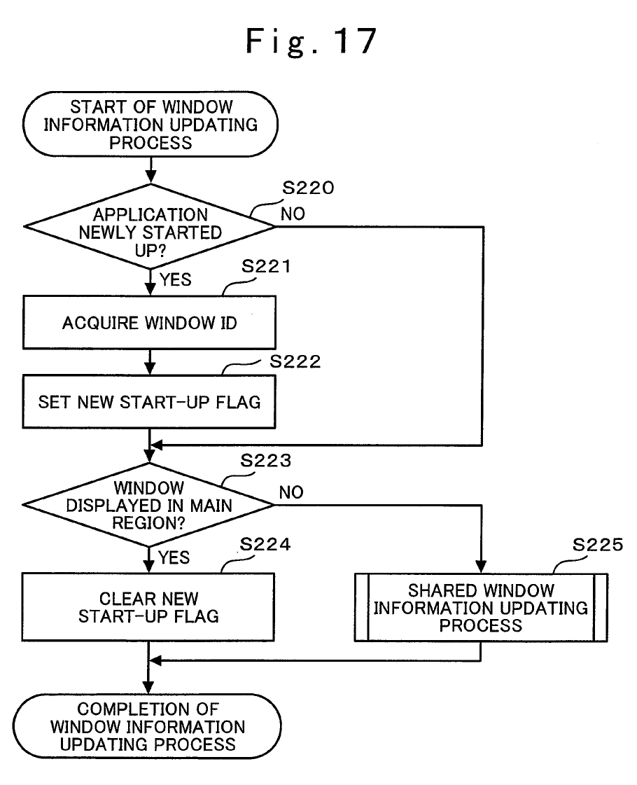

Upon completion of the connecting process in step S200, the control unit 208 determines whether or not window information is updated (step S201). If the window information is updated (Yes in step S201), the control unit 208 executes a window information updating process of controlling the updated window information (step S202) and executes a process in step S203. This process is equal to processes in steps S220 to S225 shown in FIG. 17 and will be described later. On the other hand, if the window information is not updated (No in step S201), the control unit 208 executes the process in step S203 without executing the process in step S202.

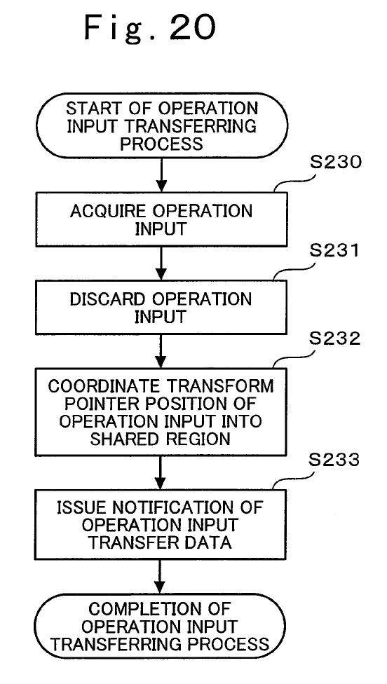

In step S203, the control unit 208 determines whether or not a window is inputted by an operation to a shared region. If the window is inputted by the operation to the shared region (Yes in step S203), the control unit 208 executes an operation input transferring process (step S204) and executes a process in step S205. This process is equal to processes in steps 230 to S233 shown in FIG. 20 and will be described later. On the other hand, if the window is not inputted by the operation to the shared region (No in step S203), the control unit 208 executes the process in step S205 without executing the process in step S204.

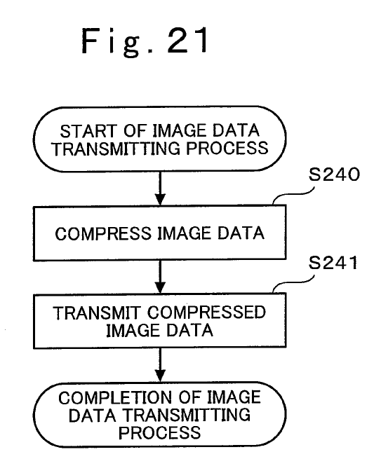

In step S205, the control unit 208 determines whether or not a shared window image is updated. If the shared window image is updated (Yes in step S205), the control unit 208 executes an image data transmitting process (step S206) and executes a process in step S207. This process is equal to processes in steps S240 and S241 shown in FIG. 21 and will be described later. On the other hand, if the shared window image is not updated (No in step S205), the control unit 208 executes the process in step S207 without executing the process in step S206.

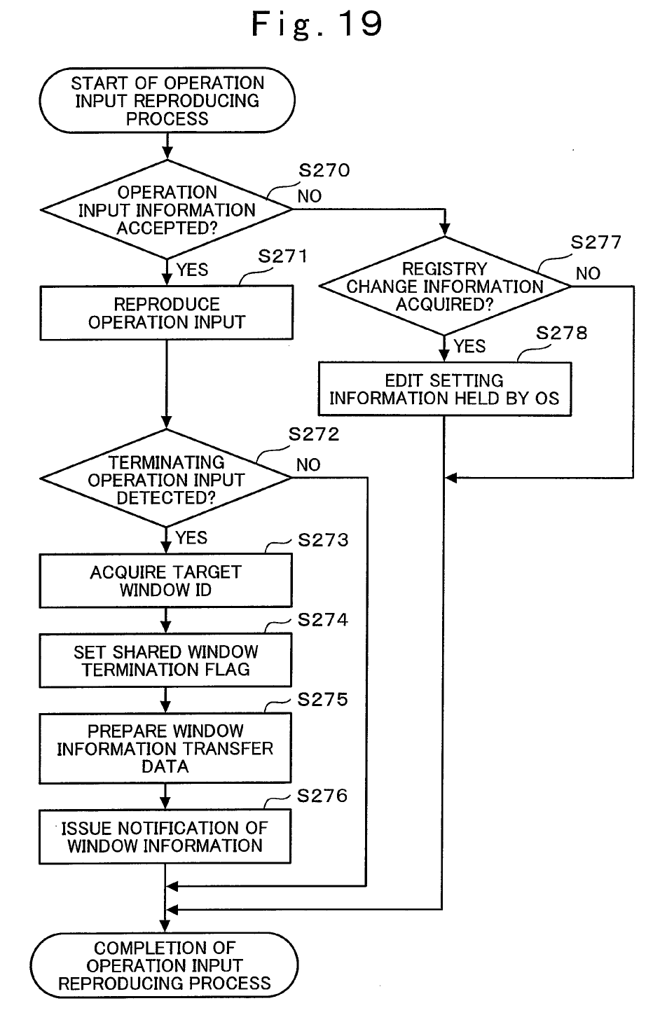

In step S207, the control unit 208 determines whether or not to receive data. If the control unit 208 receives the data (Yes in step S207), then, the control unit 208 executes an operation input reproducing process (step S208) and executes a process in step S209. This process is equal to processes in steps S270 to S278 shown in FIG. 19 and will be described later. On the other hand, if the control unit 208 receives no data (No in step S207), then, the control unit 208 executes the process in step S209 without executing the process in step S208.

In step S209, the control unit 208 determines whether or not to accept a connection canceling operation. If the control unit 208 accepts no connection canceling operation (No in step S209), then, the control unit 208 executes the process in step S201. On the other hand, if the control unit 208 accepts the connection canceling operation (Yes in step S209), then, the control unit 208 completes the main process.

### (Connecting Process)

With reference to FIG. 16, next, detailed description will be given of the connecting process in step S200. FIG. 16 shows a flowchart of the connecting process executed by the terminal apparatus 2 in this embodiment.

As shown in FIG. 16, the control unit 208 starts the connecting process, and transmits a connection request signal to the image projection apparatus 1 (step S210).

Next, the control unit 208 determines whether or not to receive information about resolution from the image projection apparatus 1 (step S211). In this process, if the control unit 208 receives the resolution information from the image projection apparatus 1 (Yes in step S211), then, the control unit 208 prepares the virtual display region 45 (the shared region) adjoining to the display region of the LCD 200 (step S212). Herein, the prepared virtual display region 45 has resolution which is set based on the resolution information received from the image projection apparatus 1 in step S211. On the other hand, if the control unit 208 receives no resolution information from the image projection apparatus 1 (No in step S211), then, the control unit 208 executes the process in step S211 again.

After completion of the process in step S212, the control unit 208 issues a notification of completion of activation to the image projection apparatus 1 (step S213). Next, the control unit 208 determines whether or not to receive a connection completion notification from the image projection apparatus 1 (step S214). If the control unit 208 receives the connection completion notification from the image projection apparatus 1 (Yes in step S214), then, the control unit 208 completes the connecting process. On the other hand, if the control unit 208 receives no connection completion notification from the image projection apparatus 1 (No in step S214), then, the control unit 208 executes the process in step S214 again.

### (Window Information Updating Process)

With reference to FIG. 17, next, detailed description will be given of the window information updating process in step S202. FIG. 17 shows a flowchart of the window information updating process executed by the terminal apparatus 2 in this embodiment.

As shown in FIG. 17, the control unit 208 starts the window information updating process, and determines whether or not an application is started up newly (step S220). This determination is made based on a fact whether or not the user conducts a predetermined operation for an image located in the display region of the LCD 200 through the mouse 207 or a fact whether or not the control unit 208 receives operation input information about generation of a new window from the image projection apparatus 1. In this process, if the application is started up newly (Yes in step S220), the control unit 208 acquires a window ID of the application (step S221), sets a new start-up flag (step S222) and executes a process in step S223. In step S220, on the other hand, if no application is started up newly (No in step S220), the control unit 208 executes a process in step S223 without executing the processes in steps S221 and S222.

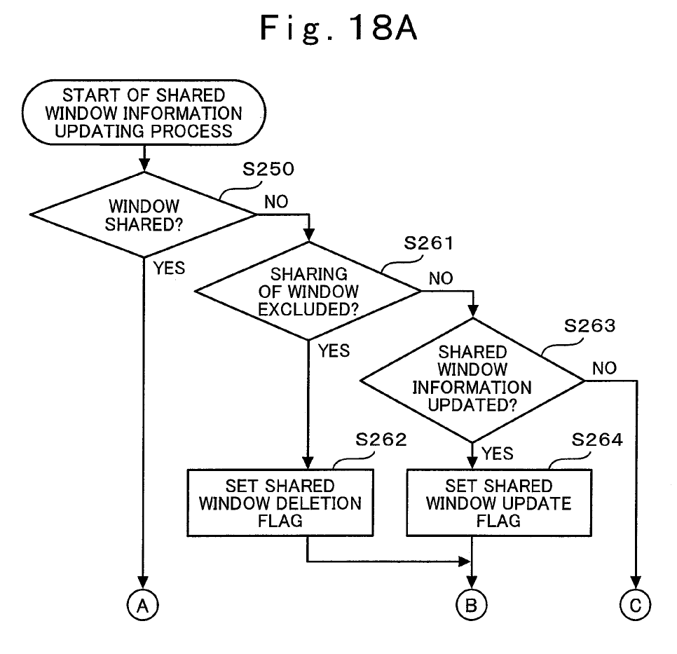

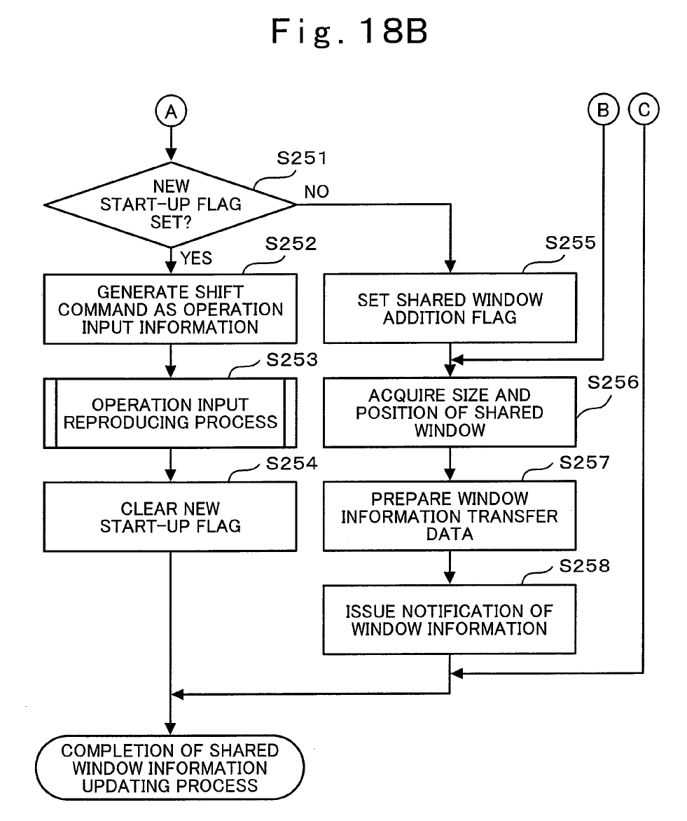

In step S223, control unit 208 determines whether or not a window generated based on the application started up newly is located in a main region. In other words, when display of an image generated based on an application is terminated and, then, the image based on the application is generated again, the control unit 208 determines whether or not a position of the stored image is in the virtual display region 45 and determines whether or not a position of the image of which the display is terminated is in the virtual display region 45. In this process, if the window is located in the main region (Yes in step S223), the control unit 208 clears the new start-up flag (step S224) and completes the window information updating process. On the other hand, if the window is not located in the main region, that is, if the window is located in the shared region (No in step S223), the control unit 208 executes a shared window information updating process of controlling the window located in the shared region (step S225) and completes the window information updating process. The process in step S225 is equal to processes in steps S250 to S264 shown in FIG. 18 and will be described later.

### (Shared Window Information Updating Process)

With reference to FIG. 18, next, detailed description will be given of the shared window information updating process in step S225. FIG. 18 shows a flowchart of the shared window information updating process executed by the terminal apparatus 2 in this embodiment.

As shown in FIG. 18, the control unit 208 starts the shared window information updating process, and determines whether or not a window is shared (step S250). In this process, if the window is shared (Yes in step S250), the control unit 208 executes a process in step S251. On the other hand, if no window is shared (No in step S250), the control unit 208 executes a process in step S261.

In step S261, the control unit 208 determines whether or not the sharing of the window is excluded. In this process, if the sharing of the window is excluded (Yes in step S261), the control unit 208 sets a shared window deletion flag (step S262) and executes a process in step S256. On the other hand, if the sharing of the window is not excluded (No in step S261), the control unit 208 determines whether or not the shared window information is updated (step S263). In this process, if the shared window information is updated (Yes in step S263), the control unit 208 sets a shared window update flag (step S264) and executes the process in step S256. On the other hand, if the shared window information is not updated (No in step S263), the control unit 208 completes the shared window information updating process.

In step S251, the control unit 208 determines whether or not a new start-up flag is set. In this process, if the new start-up flag is set (Yes in step S251), the control unit 208 generates a shift command as operation input command (step S252) and executes an operation input reproducing process (step S253) More specifically, in a case where a position of an image is in the virtual display region 45, the control unit 208 updates the position of the stored image as the common display region 40 rather than the virtual display region 45. As a result, on conditions that display of an image generated based on an application is terminated in a predetermined display region and the image based on the application is generated again, the control unit 208 changes the display position of the image to the common display region 40. This process is equal to processes in steps S270 to S278 shown in FIG. 19 and will be described later. Next, the control unit 208 clears the new start-up flag (step S254) and completes the shared window information updating process. In this embodiment, files which are equal to each other are terminated and opened based on a single application, so that the control unit 208 changes the display position of the image to the common display region 40 on the conditions that the display of the image is terminated in the virtual display region 45 and the image is generated again. However, the present invention is not limited thereto. For example, files which are different from each other may be terminated and opened based on a single application as long as the display of the image is terminated in the virtual display region 45 and the image is generated again.

On the other hand, if the new start-up flag is not set (No in step S251), the control unit 208 sets a shared window addition flag (step S255) and executes the process in step S256.

In step S256, the control unit 208 acquires a position and a size of the shared window to create window information transfer data (step S257) and sends the window information to the image projection apparatus 1 (step S258). Upon completion of this process, the control unit 208 completes the shared window information updating process.

### (Operation Input Reproducing Process)

With reference to FIG. 19, next, detailed description will be given of the operation input reproducing process in steps S208 and S253. FIG. 19 shows a flowchart of the operation input reproducing process executed by the terminal apparatus 2 in this embodiment.

As shown in FIG. 19, the control unit 208 starts the operation input reproducing process and determines whether or not to accept the operation input information (step S270). In this process, if the control unit 208 determines that the operation input information is accepted, based on information from another apparatus such as the image projection apparatus 1 or information corresponding to the operation in the terminal apparatus 2 itself (Yes in step S270), then, the control unit 208 reproduces the operation input information (step S271) and allows an application program corresponding to a data file to be operated to execute an editing operation based on the image operation command. Moreover, in a case where the operation input is start-up of an application, the control unit 208 generates image data based on the data file of the application and controls display of an image based on the generated image data. On the other hand, in a case where the operation input is termination of the application, the control unit 208 controls termination of the display of the image based on the image data and stores a position of the image.

Next, the control unit 208 determines whether or not acceptance of the terminating operation input is detected (step S272). In this process, if the acceptance of the terminating operation input is detected (Yes in step S272), the control unit 208 acquires a target window ID (step S273) and sets a shared window termination flag (step 274). Next, the control unit 208 creates window information transfer data indicating the termination of the window (step S275), sends the window information to the image projection apparatus 1 based on the window information transfer data (step S276), and completes the operation input reproducing process.

In step S272, on the other hand, if the acceptance of the terminating operation input is not detected (No in step S272), the control unit 208 completes the operation input reproducing process without executing the processes in steps S273 to S276.

In step S270, moreover, if the control unit 208 accepts no operation input information (No in step S270), then, the control unit 208 determines whether or not to acquire registry change information (step S277). In this process, if the control unit 208 acquires the registry change information (Yes in step S277), then, the control unit 208 edits setting information held by an OS (step S278) and completes the operation input reproducing process. In step S277, on the other hand, if the control unit 208 acquires no registry change information (No in step S277), then, the control unit 208 completes the operation input reproducing process without executing the process in step S278.

### (Operation Input Transferring Process)

With reference to FIG. 20, next, detailed description will be given of the operation input transferring process in step S204. FIG. 20 shows a flowchart of the operation input transferring process executed by the terminal apparatus 2 in this embodiment.

As shown in FIG. 20, the control unit 208 starts the operation input transferring process, acquires operation input information based on an operation input (step S230), and discards the operation input information in order to prevent an operation based on the operation input from being performed by the terminal apparatus 2 (step S231).

Next, the control unit 208 acquires position information of a pointer displayed in the projection region 60 projected by the image projection apparatus 1, converts the position information of the pointer into a coordinate system in the shared region (step S232), generates operation input transfer data containing the converted position information of the pointer and operation input information, and sends the operation input transfer data to the image projection apparatus 1 via the communication path 3 (step S233). Thereafter, the control unit 208 completes the operation input transferring process. In particular, upon generation of an image, the control unit 208 transmits generation information about generation of the image to the image projection apparatus 1 via the communication path 3. Upon termination of display of the image, the control unit 208 transmits termination information about termination of the display to the image projection apparatus 1 via the communication path 3.

### (Image Data Transmitting Process)

With reference to FIG. 21, next, detailed description will be given of the image data transmitting process in step S206. FIG. 21 shows a flowchart of the image data transmitting process executed by the terminal apparatus 2 in this embodiment.

As shown in FIG. 21, the control unit 208 starts the image data transmitting process, partially or entirely captures image data of an image located in the virtual display region 45 based on an image data transmission request, converts the captured image data from a BMP (Bit Map) format into a JPEG (Joint Photographic Experts Group) format to compress the image data (step S240), and transmits the compressed image data to the image projection apparatus 1 via the communication path 3 (step S241). Upon completion of the process in step S241, the control unit 208 completes the image data transmitting process. As described above, when a position of an image based on generated image data is in the virtual display region 45, the control unit 208 partially or entirely transmits the image data of the image to the image projection apparatus 1 via the communication path 3.

With the configuration described above, on conditions that display of an image is terminated in a predetermined display region and the image is generated again, in a single application, the image can be displayed in a display region other than the predetermined display region without being projected in a visually recognizable manner. Moreover, in a case where it is determined that a position of the image generated based on the application is in the predetermined display region, the position of the image is updated as the region other than the predetermined display region. Thus, the image can be displayed in the region other than the predetermined display region without being projected in a visually recognizable manner.

The embodiment of the present invention has been described in detail herein with reference to the several drawings; however, the embodiment disclosed herein is merely exemplary. The present invention may be embodied by various modifications and improvements based on the acknowledgement of those skilled in the art.

### Second Embodiment

In the foregoing embodiment, upon start-up of an application, in a case where a display position of a window corresponding to the application is in the virtual display region 45, the display position is changed from the virtual display position 45 to the common display position 40. However, the present invention is not limited thereto. For example, upon termination of an application, in a case where a display position of a window corresponding to the application is in the virtual display region 45, the display position may be changed from the virtual display region 45 to the common display region 40.

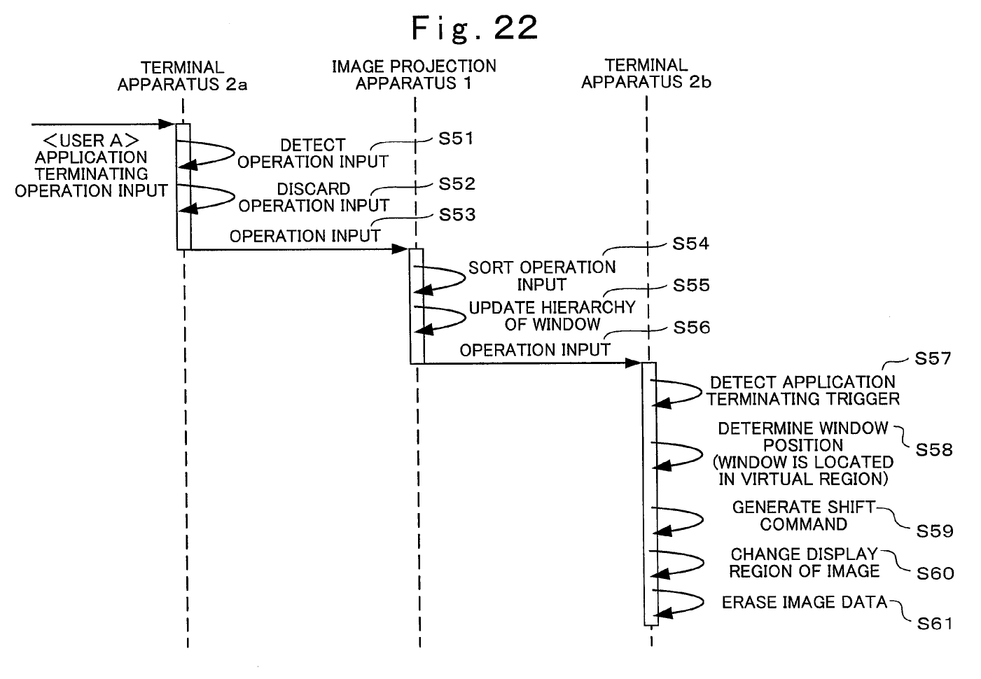

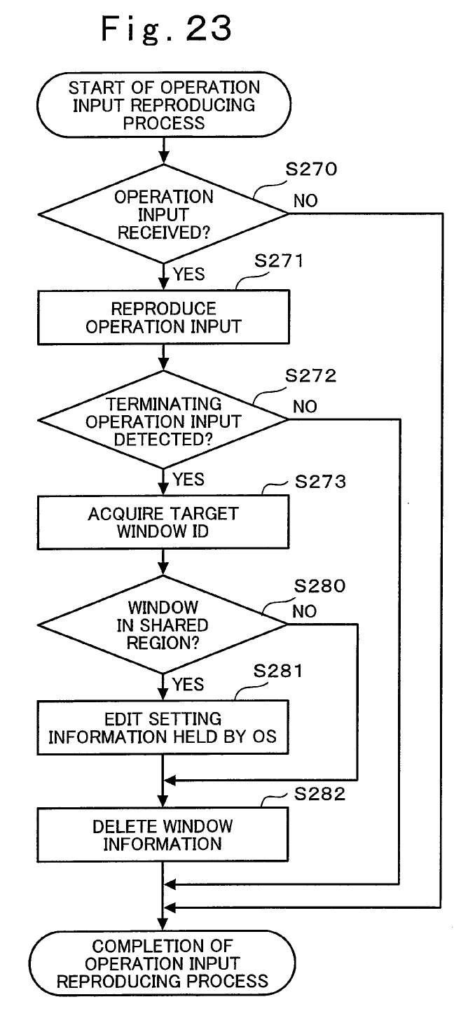

With reference to FIGS. 22 and 23, hereinafter, description will be given of the configuration described above. In order to facilitate the understanding, configurations similar to those in the foregoing embodiment will not be described here.

With reference to FIG. 22, description will be given of the editing action described above, in more detail. FIG. 22 shows a sequence diagram of one example of the editing action performed by the image projection system S in a second embodiment of the present invention.

As shown in FIG. 22, the user A of the terminal apparatus 2a conducts a predetermined operation input (e.g., shift of an image) for an image located in the virtual display region 45b of the terminal apparatus 2b among images projected by the image projection apparatus 1, so that the terminal apparatus 2a acquires an operation input (an image operation command) based on the operation (step S51). The operation input in this case is a terminating operation input for terminating an application in the virtual display region 45b of the terminal apparatus 2b.

Next, the terminal apparatus 2a discards the image operation input in order to prevent the operation conducted by the user A from being executed by the terminal apparatus 2a (step S52), and transmits the terminal operation input to the image projection apparatus 1 via the communication path 3 (step S53). Herein, the terminal apparatus 2a allows the operation command transmission unit 27 to discard the image operation input and transmit the operation input.

Upon reception of the operation input from the terminal apparatus 2a, next, the image projection apparatus 1 allows the operation command processing unit 13 to execute a process of sorting the operation input for each terminal apparatus 2 (step S54). Herein, the operation input is sorted so as to be transmitted to the terminal apparatus 2b.

Moreover, the image projection apparatus 1 updates hierarchical levels allocated to images located in the virtual display regions 45 of the respective terminal apparatuses 2, based on the received operation input and window information (image attribute information) acquired by the image acquisition unit 10 (step S55). In other words, the image projection apparatus 1 determines an operated image, based on the operation input and the window information, sets the hierarchical level of the image, which is managed by the shared window management table, at an uppermost layer, and successively lowers the hierarchical levels of the other images. Herein, the image projection apparatus 1 allows the image processing unit 11 to update the hierarchical level. Next, the image processing unit 11 of the image projection apparatus 1 allocates hierarchical levels to the image 36a located in the virtual display region 45a of the terminal apparatus 2a and the image 36b located in the virtual display region 45b of the terminal apparatus 2b, superimposes the images 36a and 36b on each other in increasing order of hierarchical level to combine the images 36a and 36b, and projects an image (a composite image) based on the composite image data.

Next, the image projection apparatus 1 allows the operation command processing unit 13 to transmit the terminating operation input, which has received from the terminal apparatus 2a in step S53, to the terminal apparatus 2b via the communication path 3 (step S56).

Upon reception of the terminating operation input, the terminal apparatus 2b detects an application terminating trigger based on the terminating operation input (step S57), reads window information corresponding to the terminating operation input, and determines whether or not a window corresponding to the window information is located in the virtual display region 45b (step S58). Next, if the window is located in the virtual display region 45b, the terminal apparatus 2b allows the image display position change unit 31 to generate a shift command for shifting the window to the common display region 40b (step S59) and changes the display region of the window image to the common display region 40b based on the shift command (step S60). Next, the terminal apparatus 2b erases the image data of the window subjected to the terminating operation input (step S61) and completes the process.

As described above, in a case where an application is started up by an operation and a display position of image data generated based on the application is in the virtual display region 45, the terminal apparatus 2 shifts the window from the virtual display region 45 to the common display region 40.

### (Operation Input Reproducing Process)

With reference to FIG. 23, detailed description will be given of an operation input reproducing process in the second embodiment which is called in steps S208 and S253 in the foregoing embodiment. In order to facilitate the understanding of this invention, processes similar to those shown in FIG. 19 are not described here. FIG. 23 shows a flowchart of the operation input reproducing process executed by the terminal apparatus 2 in the second embodiment.

As shown in FIG. 23, the control unit 208 reproduces an operation input in step S271. In this case, upon reception of an operation input concerning termination of display of a window from the image projection apparatus 1, the control unit 208 terminates the display of the window, based on the operation input.

Upon completion of the process in step S273, the control unit 208 determines whether or not a window of which window ID is acquired is located in the shared region (the virtual display region 45) (step S280). In other words, upon termination of the display, the control unit 208 determines whether or not the position of the stored image is in the predetermined display region. In this process, if the window is located in the shared region (Yes in step S280), the control unit 208 terminates the display of the window, edits setting information held by the OS (step S281), shifts the window from the virtual display region 45 to the common display region 40, and executes a process in step S282. In other words, if the position of the image is in the virtual display region 45, the control unit 208 updates the position of the stored image as the common display region 40 rather than the virtual display region 45. Accordingly, if the position of the image is in the predetermined display region upon termination of the display of the image, the position of the image is changed to the region other than the predetermined display region, so that the image can be displayed in the region other than the predetermined display region without being projected in a visually recognizable manner. In this embodiment, each terminal apparatus 2 holds as table data window information started up thereby; therefore, the window information is not necessarily correlated with the owner PC in the shared window management table shown in FIG. 11.

On the other hand, if the window is not located in the shared region (No in step S280), the control unit 208 executes the process in step S282 without executing the process in step S281. In step S282, next, the control unit 208 deletes the window information of the target window from the shared window management table. Upon completion of this process, the control unit 208 completes the operation input reproducing process.

In the second embodiment, in the case where the display of the window is terminated in the terminal apparatus 2b based on the terminating operation input in the terminal apparatus 2a, the terminal apparatus 2b determines whether or not the window is located in the virtual display region 45b. If the window is located in the virtual display region 45b, the terminal apparatus 2b edits the setting information in order to shift the window to the common display region 40b. However, the present invention is not limited thereto. For example, the following configuration may be applied. That is, in the case where the display of the window is terminated in the terminal apparatus 2a based on the terminating operation input in the terminal apparatus 2a, the terminal apparatus 2a determines whether or not the window is located in the virtual display region 45a. If the window is located in the virtual display region 45a, the terminal apparatus 2a edits the setting information in order to shift the window to the common display region 40a.

### Third Embodiment

In the foregoing embodiment, the terminal apparatus 2 determines whether or not a window is located in the virtual display region 45. However, the present invention is not limited thereto. For example, the image projection apparatus 1 may make such a determination.

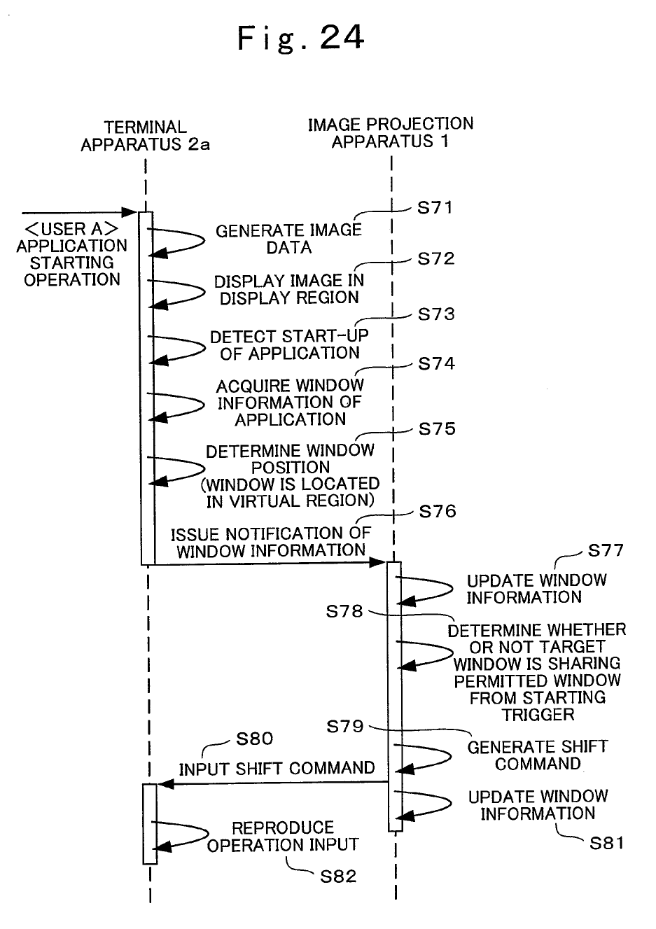

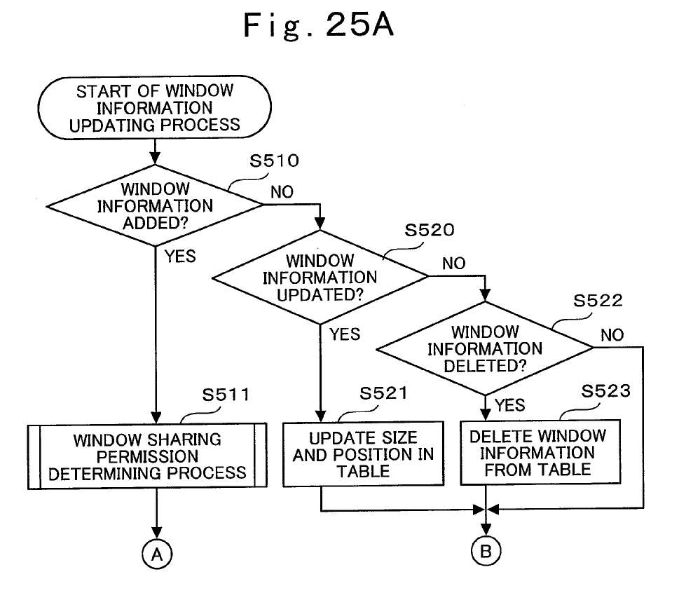

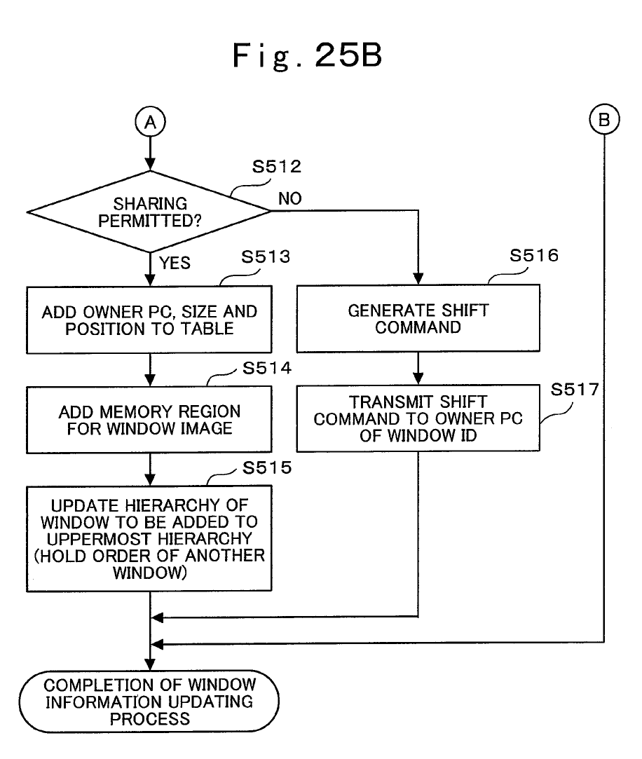

With reference to FIGS. 24 and 25, hereinafter, description will be given of the configuration described above. In order to facilitate the understanding, configurations similar to those in the foregoing embodiment will not be described here.

With reference to FIG. 24, description will be given of an application starting action. FIG. 24 shows a sequence diagram of one example of the application starting action performed by the image projection systems in a third embodiment of the present invention.

As shown in FIG. 24, first, the user A conducts an executing operation for application programs of the terminal apparatus 2a, so that the terminal apparatus 2a executes a target application program to generate image data in accordance with a data file of the application (step S71). Herein, the user A conducts the application program executing operation through the operation unit 26. The terminal apparatus 2a allows the image generation unit 21 to generate the image data based on the data file, as described above, and then allows the display unit 24 to display an image based on the generated image data (step S72).

Next, the terminal apparatus 2a detects start-up of an application which is started up newly (step S73), and allows the display control unit 29 to acquire window information of the application (step S74). Next, the terminal apparatus 2a determines a display position of a window (step S75). If the window is displayed in the virtual display region 45a, the terminal apparatus 2a transmits updated image attribute information (window information) to the image projection apparatus 1 (step S76).

Upon reception of window information from each terminal apparatus 2, next, the image projection apparatus 1 allows the terminal connection management unit 15 to update the information in the shared window management table (step S77). The shared window management table manages image attribute information about a plurality of pieces of image data acquired from the respective terminal apparatuses 2 and is stored in the predetermined region of the memory unit 14 of the image projection apparatus 1.

Next, the image projection apparatus 1 determines whether or not sharing of the window is permitted, based on a starting trigger (window information) (step S78). If the sharing of the window is permitted, the image projection apparatus 1 generates a shift command for shifting the window to the common display region 40a (step S79) and transmits the shift command to the terminal apparatus 2a (step S80). Next, the image projection apparatus 1 allows the terminal connection management unit 15 to update the information in the shared window management table, based on the shift command (step S81) and completes the process.

On the other hand, upon reception of the shift command, the terminal apparatus 2a changes the display region of the window image to the common display region 40a, based on the shift command, and completes the process.

As described above, in the case where the application is started up by the operation and the display position of the image data generated based on the application is in the virtual display region 45, the terminal apparatus 2 shifts the window from the virtual display region 45 to the common display region 40.

### (Window Information Updating Process)

With reference to FIG. 25, next, detailed description will be given of the window information updating process in step S503. FIG. 25 shows a flowchart of the window information updating process executed by the image projection apparatus 1 in the third embodiment.

As shown in FIG. 25, the control unit 108 starts the window information updating process and determines whether or not window information is added, based on the window information from the terminal apparatus 2 (step S510). In this process, if the window information is added (Yes in step S510), the control unit 108 executes a window sharing permission determining process of determining whether or not sharing of a window is permitted, based on the window information (step S511). If the sharing of the window is permitted (Yes in step S512), the control unit 108 executes a process in step S513. On the other hand, if the sharing of the window is not permitted (No in step S512), the control unit 108 executes a process in step S516. In this embodiment, in a case where the window is located in the virtual display region 45 and is set so as to permit sharing, the sharing of the window is permitted. In other words, upon reception of generation information from the terminal apparatus 2 via the communication path 3, the control unit 108 determines whether or not a position of a generated image is in the predetermined display region, thereby determining whether or not a position of an image of which display is terminated is in the virtual display region 45 Herein, the control unit 108 functions as the image position determination unit.

In step S513, based on the received window information, the control unit 108 adds an owner PC, a window size and a window position in the window information to the shared window management table, and adds a memory region for a window image corresponding to the window information (step S514). Next, the control unit 108 updates a hierarchy of the window information to be added at an uppermost layer, lowers an order of another window information by one and holds this order (step S515). Thereafter, the control unit 108 completes the window information updating process.

In step S516, the control unit 108 generates a shift command for shifting the received window information from the virtual display region 45 to the common display region 40. Next, the control unit 108 transmits the shift command to an owner PC identified by a window ID (step S517) and completes the window information updating process. In other words, if a position of an image is in the virtual display region 45, the control unit 108 transmits image position shift information about shift of the position of the image to the terminal apparatus 2 via the communication path 3. Herein, the control unit 108 functions as an image position shift information transmission unit.

Upon reception of the shift command from the image projection apparatus 1, the terminal apparatus 2 shifts the window from the virtual display region 45 to the common display region 40, based on the shift command. As described above, the image projection apparatus 1 shifts the window from the virtual display region 45 to the common display region 40 in the terminal apparatus 2. In other words, upon reception of the image position shift information from the image projection apparatus 1 via the communication path 3, the control unit 208 of the terminal apparatus 2 changes the display position of the image to the common display region 40 rather than the virtual display region 45.

On the other hand, if no window information is added (No in step S510), the control unit 108 determines whether or not the window information is updated, based on the window information from the terminal apparatus 2 (step S520). In this process, if the window information is updated (Yes in step S520), the control unit 108 updates the window size and the window position in the shared window management table, based on the window information (step S521). Thereafter, the control unit 108 completes the window information updating process.

On the other hand, if no window information is updated (No in step S520), the control unit 108 determines whether or not the window information is deleted, based on the window information from the terminal apparatus 2 (step S522). In this process, if the window information is deleted (Yes in step S522), the control unit 108 deletes the window information in the shared window management table, based on the window information (step S523). Thereafter, the control unit 108 completes the window information updating process. On the other hand, if no window information is deleted (No in step S522), the control unit 108 completes the window information updating process without executing the process in step S522.

### Fourth Embodiment

In the foregoing embodiment, the image projection apparatus 1 determines whether or not sharing of a window is permitted, based on window information received from the terminal apparatus 2. However, the present invention is not limited thereto. For example, the image projection apparatus 1 may determine whether or not the sharing of the window is permitted, based on a change amount (a shift amount) or an area increase rate of an image displayed in accordance with the window information.

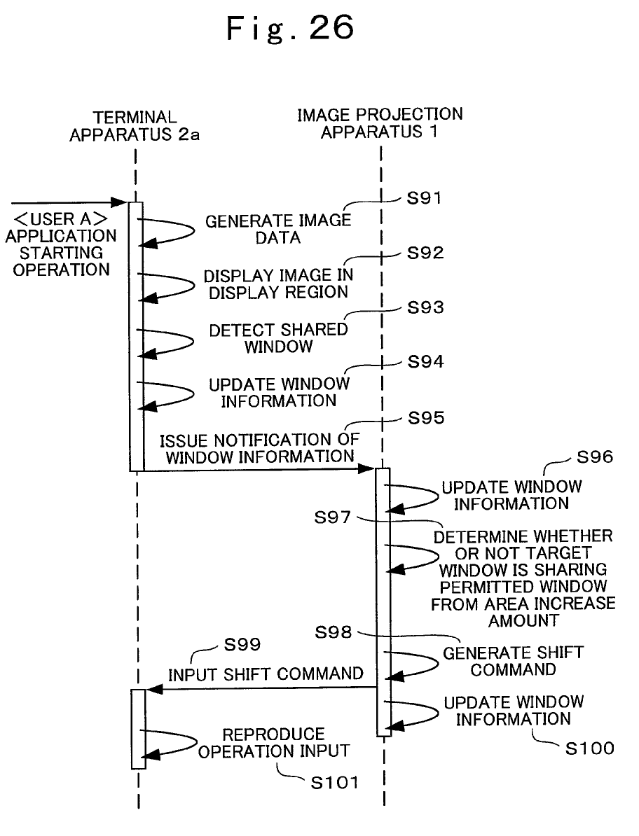

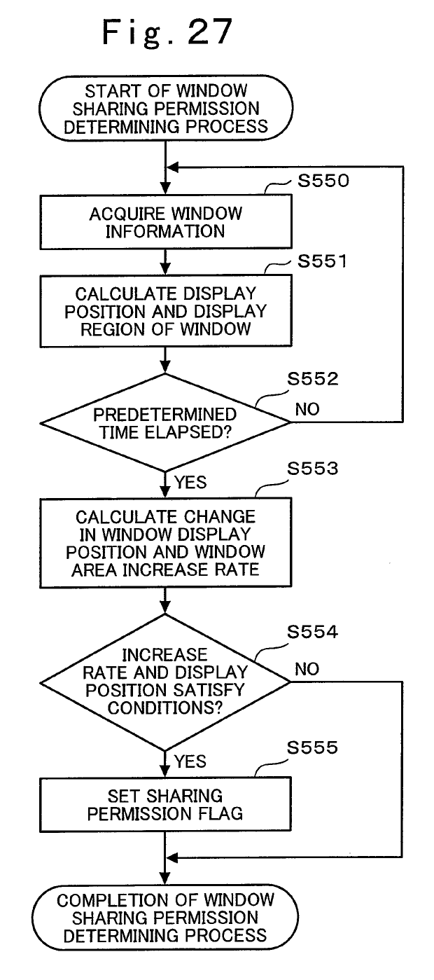

With reference to FIGS. 26 and 27, hereinafter, description will be given of the configuration described above. In order to facilitate the understanding, configurations similar to those in the foregoing embodiment will not be described here.

With reference to FIG. 26, description will be given of an application starting action. FIG. 26 shows a sequence diagram of one example of the application starting action performed by the image projection system S in a fourth embodiment of the present invention.

As shown in FIG. 26, first, the user A conducts an executing operation for application programs of the terminal apparatus 2a, so that the terminal apparatus 2a executes a target application program and generates image data in accordance with a data file of the application (step S91). Herein, the user A conducts the application program executing operation through the operation unit 26. The terminal apparatus 2a allows the image generation unit 21 to generate the image data based on the data tile, as described above, and allows the display unit 24 to display an image based on the generated image data (step S92).

Next, the terminal apparatus 2a detects a shared window (step S93), and allows the display control unit 29 to acquire window information of the application (step S94). Next, the terminal apparatus 2a transmits updated image attribute information (window information) to the image projection apparatus 1 (step S95)

Upon reception of window information from each terminal apparatus 2, the image projection apparatus 1 allows the terminal connection management unit 15 to update the information in the shared window management table (step S96). The shared window management table manages image attribute information about a plurality of pieces of image data acquired from the respective terminal apparatuses 2 and is stored in the predetermined region of the memory unit 14 of the image projection apparatus 1.

Based on the received window information, next, the image projection apparatus 1 determines whether or not sharing of a window is permitted, from an area increase amount of a window image in the window information (step S97). If the sharing of the window is permitted, the image projection apparatus 1 generates a shift command for shifting the window to the common display region 40 (step S98) and transmits the shift command to the terminal apparatus 2a (step S99). Based on the shift command, next, the image projection apparatus 1 allows the terminal connection management unit 15 to update the information in the shared window management table (step S100), and completes the process.

On the other hand, upon reception of the shift command, the terminal apparatus 2a changes a display region of the window image to the common display region 40, based on the shift command. Thereafter, the terminal apparatus 2a completes the process.

As described above, the image projection apparatus 1 determines the shift amount of the window image from the area increase rate of the window image. Based on the shift amount of the window image, the image projection apparatus 1 determines whether or not to shift the window from the virtual display region 45 to the common display region 40.

### (Shared Window Information Updating Process)

With reference to FIG. 27, next, detailed description will be given of the shared window information updating process in step S511. FIG. 27 shows a flowchart of the shared window updating process executed by the image projection apparatus 1 in the fourth embodiment.

As shown in FIG. 27, the control unit 108 starts the shared window information updating process, acquires window information (step S550), and calculates a window display position and a window display region based on the window information (step S551). Next, the control unit 108 determines whether or not a predetermined time has elapsed within a predetermined period of time (step S552). If the predetermined time has not elapsed yet (No in step S552), the control unit 108 executes the processes in steps S550 and S551 again. On the other hand, if the predetermined time has elapsed (Yes in step S552), the control unit 108 executes a process in step S553. In step S553, the control unit 108 calculates a change in window display position and an area increase rate in the predetermined period of time. In other words, the control unit 108 detects increase/decrease of a display area of a projected image. Herein, the control unit 108 functions as an image projection area detection unit.

Next, the control unit 108 determines whether or not the change in window display position and the window area increase rate, each of which is calculated as described above, satisfy predetermined conditions (step S554). In other words, the control unit 108 determines whether or not an image is generated in the virtual display region 45, based on a result of the detection of the increase/decrease of the display area of the projected image. Herein, the control unit 108 functions as an image generation determination unit. In this process, if the change in window display position and the window area increase rate satisfy the predetermined conditions (Yes in step S554), the control unit 108 sets a sharing permission flag (step S555) and completes the shared window information updating process, so that the window can be recognized as a sharing permitted window. On the other hand, if the change in window display position and the window area increase rate do not satisfy the predetermined conditions (No in step S554), the control unit 108 completes the shared window information updating process without executing the process in step S555, so that the window can not be recognized as a sharing permitted window. As one specific example, on conditions that the window is not changed so much based on the change in window display position and the window area increase rate even when the predetermined time has elapsed, the control unit 108 permits sharing of the window.

The image projection apparatus 1 executes the processes described above, thereby determining whether or not the window is a sharing permitted window, based on the change in window display position and the window area increase amount. Thus, a fact that an image is generated in the virtual display region 45 can be recognized from increase/decrease of an image display area.

In the fourth embodiment, the control unit 108 determines whether or not an image is generated in the virtual display region 45, based on the detection result of the increase/decrease of the display area of the projected image. However, the present invention is not limited thereto. For example, the control unit 108 may determine whether or not display of an image in the virtual display region 45 is terminated, based on the detection result of the increase/decrease of the display area of the projected image. Herein, the control unit 108 functions as an image termination determination unit. Thus, upon reception of image position shift information from the image projection apparatus 1 via the communication path 3, the control unit 208 of the terminal apparatus 2 updates a position of a stored image as the common display region 40 rather than the virtual display region 45. Accordingly, a fact that display of an image in the predetermined display region is terminated can be recognized from the increase/decrease of the image display area.

In the fourth embodiment, moreover, the image projection apparatus 1 detects increase/decrease of a display area of a projected image, and determines whether or not an image is generated in the virtual display region 45 or determines whether or not display of an image in the virtual display region 45 is terminated, based on a result of the detection of the increase/decrease of the image display area. However, the present invention is not limited thereto. For example, the following condition may be applied. That is, the terminal apparatus 2 detects increase/decrease of a display area of an image in the virtual display region 45, and determines whether or not an image is generated in the virtual display region 45 or determines whether or not display of an image in the virtual display region 45 is terminated, based on a result of the detection of the increase/decrease of the image display area. Herein, the control unit 208 functions as the image projection area detection unit, the image generation determination unit, and the image termination determination unit.

### Fifth Embodiment

In the foregoing embodiment, upon start-up of an application, the image projection apparatus 1 determines whether or not a window display position is in the virtual display region 45. However, the present invention is not limited thereto. For example, upon completion of an application, the image projection apparatus 1 may determine whether or not a window display position is in the virtual display region 45.

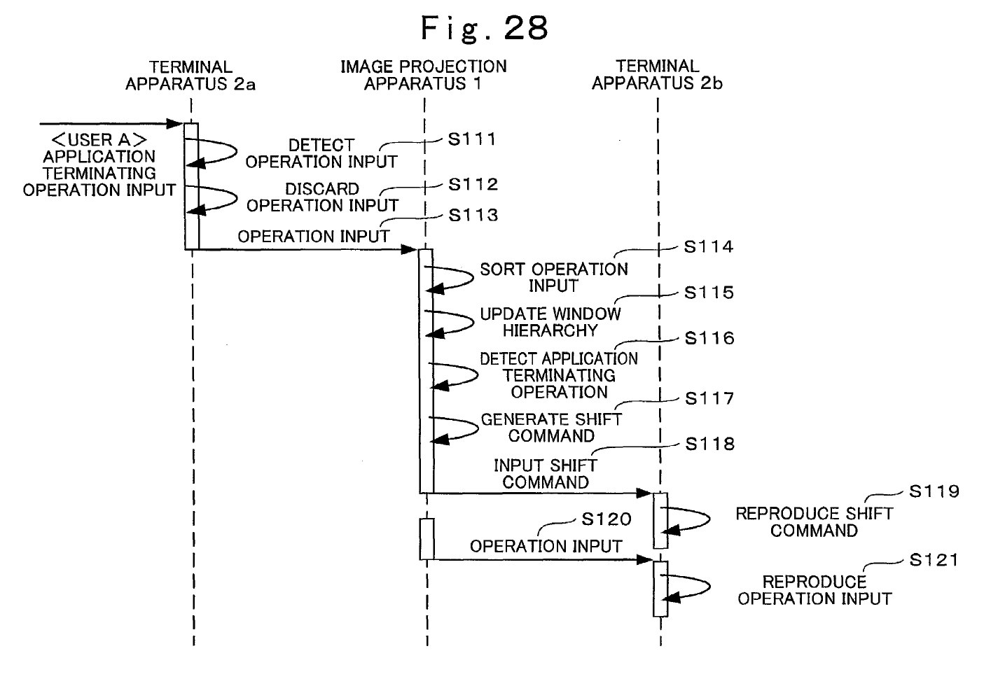

With reference to FIGS. 28 to 30, hereinafter, description will be given of the configuration described above. In order to facilitate the understanding, configurations similar to those in the foregoing embodiment will not be described here.

With reference to FIG. 28, description will be given of the foregoing editing action in more detail. FIG. 28 shows a sequence diagram of one example of the editing action performed by the image projection system S in a fifth embodiment of the present invention.

As shown in FIG. 28, the user A of the terminal apparatus 2a conducts a predetermined operation input (e.g., click of an image display termination button) for an image located in the virtual display region 45b of the terminal apparatus 2b among images projected by the image projection apparatus 1, so that the terminal apparatus 2a acquires an operation input (an image operation command) based on the operation (step S111). In this case, the operation input is a terminating operation input for terminating an application in the virtual display region 45b of the terminal apparatus 2b.

Next, the terminal apparatus 2a discards the image operation input in order to prevent the operation conducted by the user A from being executed by the terminal apparatus 2a (step S112), and transmits the terminating operation input to the image projection apparatus 1 via the communication path 3 (step S113). Herein, the terminal apparatus 2a allows the operation command transmission unit 27 to discard the image operation input and transmit the operation input.

Upon reception of the operation input from the terminal apparatus 2a, next, the image projection apparatus 1 allows the operation command processing unit 13 to perform a process of sorting the operation input for each terminal apparatus 2 (step S114). Herein, the operation input is sorted so as to be transmitted to the terminal apparatus 2b.

Moreover, the image projection apparatus 1 updates hierarchical levels allocated to images located in the virtual display regions 45 of the respective terminal apparatuses 2, based on the received operation input and window information (image attribute information) acquired by the image acquisition unit 10 (step S115).

Next, the image projection apparatus 1 detects an application terminating operation, based on the terminating operation input (step S116), generates a shift command (step S117), and changes a display region of a window image to the common display region 40, based on the shift command (step S118) Next, the image projection apparatus 1 allows the operation command processing unit 13 to transmit the terminating operation input, which has received from the terminal apparatus 2a in step S113, to the terminal apparatus 2b via the communication path 3 (step S120).

Upon reception of the shift command, the terminal apparatus 2b shifts a window, which is displayed in the virtual display region 45b and is designated by the shift command, from the virtual display region 45b to the common display region 40b (step S119). Upon reception of the terminating operation input, moreover, the terminal apparatus 2b erases image data of the window subjected to the terminating operation input (step S121) Thereafter, the terminal apparatus 2b completes the process.

### (Operation Input Sorting Process)

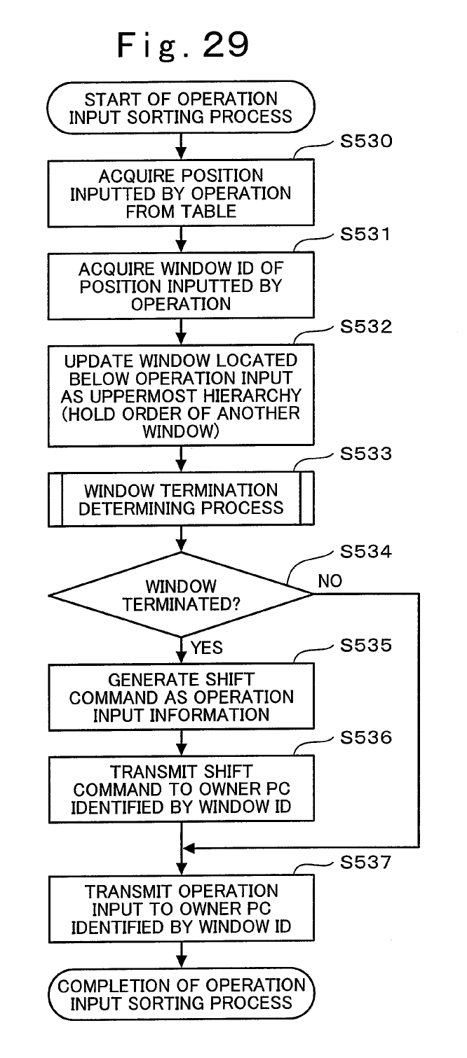

With reference to FIG. 29, next, detailed description will be given of the operation input sorting process in step S511. FIG. 29 is a flowchart of the operation input sorting process executed by the image projection apparatus 1 in the fifth embodiment.

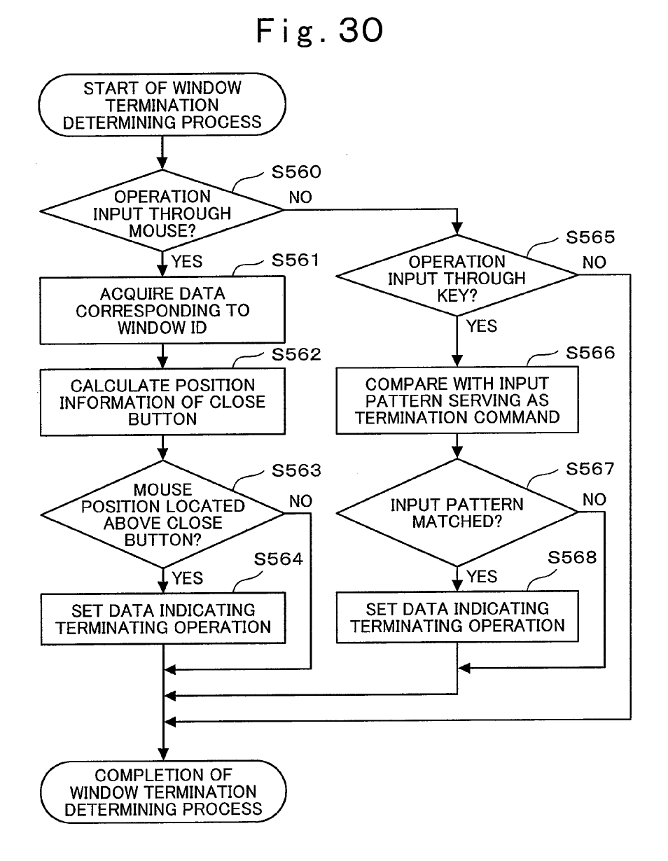

As shown in FIG. 29, the control unit 108 starts the operation input sorting process, acquires an operation position inputted by an operation from the pointer information management table (step S530), and acquires a window ID of a window located at the position inputted by the operation (step S531). Next, the control unit 108 updates a hierarchy of window information corresponding to a window located below the operation input to an uppermost layer, lowers an order of another window information by one and holds this order (step S532). Next, the control unit 108 executes a window termination determining process of determining whether or not an application corresponding to the window is terminated (step S533). This process is equal to processes in steps S560 to S568 shown in FIG. 30 and will be described later.

Next, the control unit 108 determines whether or not the application corresponding to the window is terminated (step S534). In other words, upon reception of termination information from the terminal apparatus 2 via the communication path 3, the control unit 108 determines whether or not a position of a stored image is in the virtual display region 45. Herein, the control unit 108 functions as the image position determination unit. In this process, if the application corresponding to the window is terminated (Yes in step S534), the control unit 108 generates a shift instruction as operation input information (a shift command) (step S535), transmits the shift instruction to an owner PC identified by the window ID (step S536), and executes a process in step S537. Herein, the operation input information is a shift command for changing the position of the window to the common display region 40. In other words, if a position of an image is in the virtual display region 45, the control unit 108 transmits image position shift information about shift of the position of the image to the terminal apparatus 2 via the communication path 3. Herein, the control unit 108 functions as the image position shift information transmission unit. Thus, in a case where a window is located in the virtual display region 45, the terminal apparatus 2 serving as the owner PC shifts the window to the common display region 40. In other words, upon reception of image position shift information from the image projection apparatus 1 via the communication path 3, the control unit 208 of the terminal apparatus 2 changes an image display position from the virtual display region 45 to the common display region 40. In this process, on the other hand, if the application corresponding to the window is not terminated (No in step S534), the control unit 108 executes the process in step S537 without executing the processes in steps S535 and S536. In step S537, the control unit 108 transmits the operation input to the owner PC identified by the window ID. Thus, the terminal apparatus 2 serving as the owner PC reproduces (executes) a process corresponding to the operation input for the window, and completes the operation input sorting process. In other words, in a case where a position of an image is in the virtual display region 45, when an image operation command is an image termination command, the control unit 108 transmits the image termination command to the terminal apparatus, which has transmitted image data of the image to be operated based on the image operation command, via the communication path in order to shift the image to the display region other than the virtual display region 45 and to terminate display of the image. Herein, the control unit 108 functions as the operation command processing unit.

### (Window Termination Determining Process)

With reference to FIG. 30, next, detailed description will be given of a window termination determining process in steps S533 and S253. FIG. 30 shows a flowchart of the window termination determining process executed by the image projection apparatus 1 in the fifth embodiment.

As shown in FIG. 30, the control unit 108 determines whether or not an operation input is accepted through a mouse (step S560). In this process, if the operation input is accepted through the mouse (Yes in step S560), the control unit 108 acquires data corresponding to a window ID (step S561). Next, the control unit 108 calculates position information about a close button (step S562), and determines whether or not the mouse is positioned on the close button (step S563). If the mouse is positioned on the close button (Yes in step S563), the control unit 108 sets data indicating a terminating operation (step S564), and completes the window termination determining process. On the other hand, if the mouse is not positioned on the close button (No in step S563), the control unit 108 completes the window termination determining process without executing the process in step S564. Thus, an operation for terminating an application corresponding to a window can be detected by an operation conducted through the mouse.

On the other hand, if the operation input is not accepted through the mouse (No in step S560), the control unit 108 determines whether or not the operation input is accepted through keys (step S565). In this process, if the operation input is accepted through the keys (Yes in step S565), the control unit 108 compares the operation input accepted through the keys with an input pattern serving as a termination command (step S566), and determines whether or not the operation input matches with the input pattern (step S567). If the operation input matches with the input pattern (Yes in step S567), the control unit 108 sets data indicating a terminating operation (step S568), and completes the window termination determining process. On the other hand, if the operation input does not match with the input pattern (No in step S567), the control unit 108 completes the window termination determining process without executing the process in step S568. Thus, an operation for terminating an application corresponding to a window can be detected by an operation conducted through the keys. Moreover, if the operation input is not accepted through the keys (No in step S565), the control unit 108 completes the window termination determining process.

Upon reception of an image termination command from the image projection apparatus 1 via the communication path 3, the control unit 208 of the terminal apparatus 2 shifts an image from the virtual display region 45 to the common display region 40 in accordance with the image termination command and terminates display of the image.

Accordingly, even in a case where the terminal apparatus fails to recognize termination of display of an image, for example, even in a case where the terminal apparatus receives a command to terminate display of an image from another terminal apparatus, the image projection apparatus, which can recognize the termination, issues a notification of the termination to the terminal apparatus. Thus, the terminal apparatus shifts the image from the predetermined display region to the display region different from the predetermined display region to terminate the display of the image. Even in a case where the image is generated again, the image can be displayed in the region other than the predetermined display region without being projected in a visually recognizable manner.

### Sixth Embodiment

In the foregoing embodiment, upon termination of an application, the image projection apparatus 1 determines whether or not a display position of a window is in the virtual display region 45. As a result, if the display position is in the virtual display region 45, the image projection apparatus 1 transmits to the terminal apparatus 2 a shift command for shifting the window and an operation input for terminating the application in this order. However, the present invention is not limited thereto. For example, the following configuration may be applied. That is, the image projection apparatus 1 transmits an operation input for terminating an application to the terminal apparatus 2, and determines whether or not a display position of a window is in the virtual display region 45. As a result, if the display position is in the virtual display region 45, the image projection apparatus 1 transmits a shift command for shifting the window to the terminal apparatus 2.

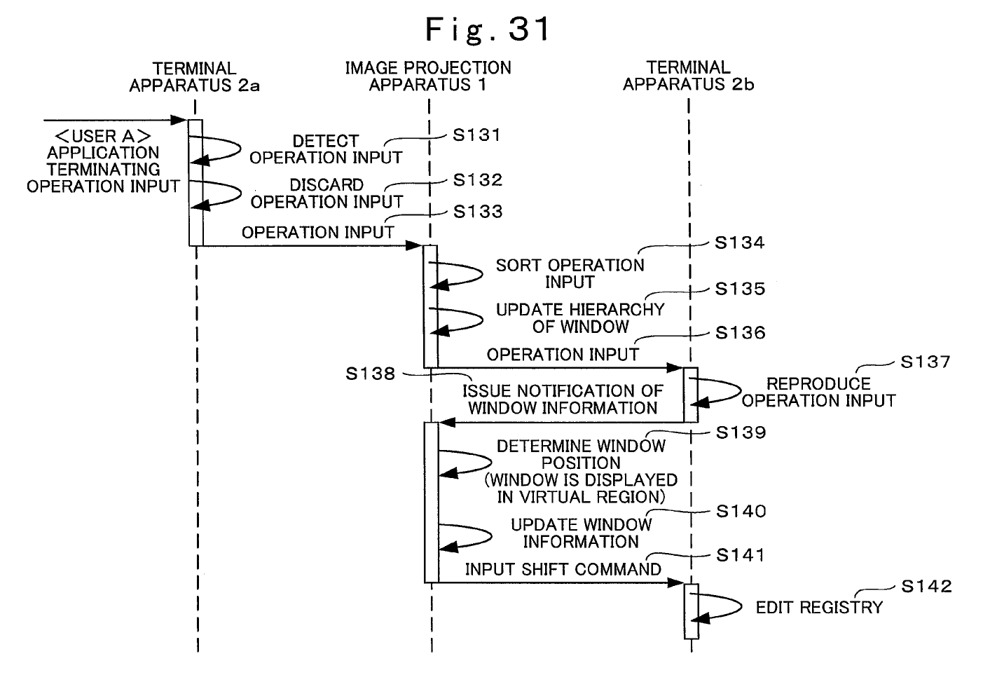

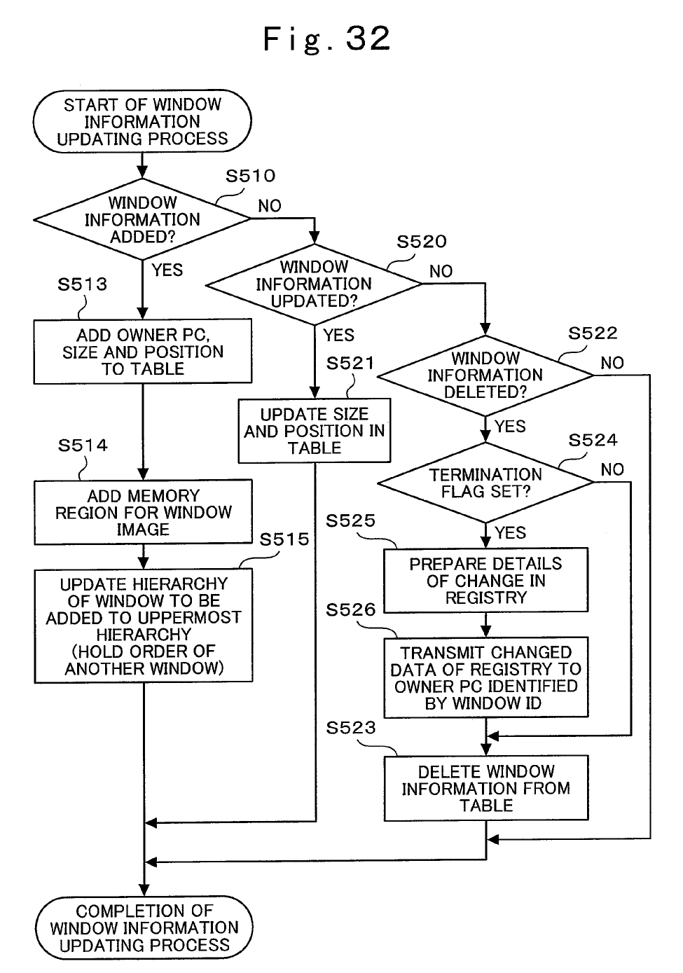

With reference to FIGS. 31 and 32, hereinafter, description will be given of the configuration described above. In order to facilitate the understanding, configurations similar to those in the foregoing embodiment will not be described here.

With reference to FIG. 31, description will be given of the foregoing editing action in more detail. FIG. 31 shows a sequence diagram of one example of the editing action performed by the image projection system S in a sixth embodiment of the present invention.

As shown in FIG. 31, the user A of the terminal apparatus 2a conducts a predetermined operation input (e.g., click of an image display termination button) for an image located in the virtual display region 45b of the terminal apparatus 2b among images projected by the image projection apparatus 1, so that the terminal apparatus 2a acquires an operation input (an image operation command) based on the operation (step S131). In this case, the operation input is a terminating operation input for terminating an application in the virtual display region 45b of the terminal apparatus 2b.

Next, the terminal apparatus 2a discards the image operation input in order to prevent the operation conducted by the user A from being executed by the terminal apparatus 2a (step S132), and transmits the terminating operation input to the image projection apparatus 1 via the communication path 3 (step S133). Herein, the terminal apparatus 2a allows the operation command transmission unit 27 to discard the image operation input and transmit the operation input.

Upon reception of the operation input from the terminal apparatus 2a, next, the image projection apparatus 1 allows the operation command processing unit 13 to perform a process of sorting the operation input for each terminal apparatus 2 (step S134) Herein, the operation input is sorted so as to be transmitted to the terminal apparatus 2b.

Moreover, the image projection apparatus 1 updates hierarchical levels allocated to images located in the virtual display regions 45 of the respective terminal apparatuses 2, based on the received operation input and window information (image attribute information) acquired by the image acquisition unit 10 (step S135). Next, the image projection apparatus 1 transmits the terminating operation input to the terminal apparatus 2b serving as an owner PC of a window subjected to the terminating operation input (step S136).

Upon reception of the terminating operation input, the terminal apparatus 2b erases image data of the window subjected to the terminating operation input (step S137), and sends window information about the deletion of the window to the image projection apparatus 1 (step S138).

Upon reception of the window information about the deletion of the window from the terminal apparatus 2b, the image projection apparatus 1 determines a display position of the deleted window (step S139). If the window has been displayed in the virtual display region 45, the image projection apparatus 1 updates the window information (step S140) and transmits a shift command for shifting the window to the common display region 40 to the terminal apparatus 2b (step S141).

Upon reception of the shift command, the terminal apparatus 2b edits a registry based on the shift command so as to change the display position of the window from the virtual display region 45 to the common display region 40 (step S142). Thus, when the application corresponding to the window is started up subsequently, the window is displayed in the common display region 40 rather than the virtual display region 45.

### (Window Information Updating Process)

With reference to FIG. 32, next, detailed description will be given of the window information updating process in step S503. FIG. 32 is a flowchart of the window information updating process executed by the image projection apparatus 1 in the sixth embodiment.

As shown in FIG. 32, when window information is added in step S510, the image projection apparatus 1 executes the processes in steps S513 to S515, and completes the window information updating process.

In step S522, if the window information is deleted (Yes in step S522), the control unit 108 determines whether or not a termination flag is set (step S524). In this process, if the termination flag is set (Yes in step S524), the control unit 108 prepares details of a change in registry such that the display position of the window is changed to the common display region 40 (step S525), transmits changed data (a shift command) containing the details of the change in registry to the terminal apparatus 2 serving as an owner PC identified by an window ID (step S526), and executes the process in step S523.

If no termination flag is set (No in step S524), the control unit 108 executes the process in step S523 without executing the processes in steps S525 and S526.

Upon termination of an application, thus, the image projection apparatus 1 determines whether or not a window corresponding to the application is located in the virtual display region 45 and allows the terminal apparatus 2 to shift the window from the virtual display region 45 to the common display region 40.

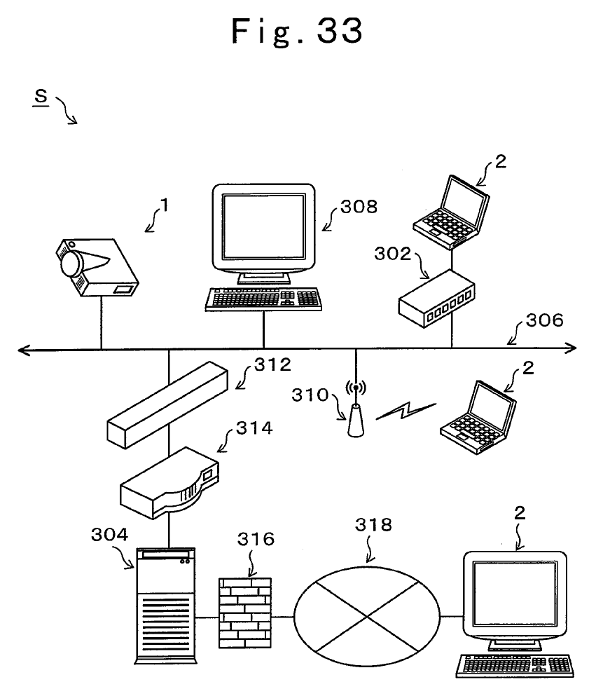

In the foregoing embodiment, the image projection apparatus 1 and the terminal apparatuses 2 are connected to each other as shown in FIG. 1. As shown in FIG. 33, alternatively, the image projection apparatus 1 and the terminal apparatuses 2 may be connected to each other through a hub 302, a server 304 or the like. Moreover, a terminal apparatus 308 such as a personal computer may be connected to an intranet 306. Moreover, the terminal apparatus 2 may be connected to the intranet 306 in a wireless manner through an access point 310 which is connected to the intranet 306. Moreover, a switching hub 312 may be connected to the intranet 306. Further, the switching hub 312 may be connected to a terminal apparatus 2 such as a personal computer through a router 314, the server 304, a firewall 316 and the Internet 318.

Although the embodiments and modifications of the present invention have been described in detail herein, the scope of the invention is not limited thereto. It will be appreciated by those skilled in the art that various modifications may be made without departing from the scope of the invention. Accordingly, the embodiments and modifications disclosed herein are only exemplary. It is to be understood that the scope of the invention is not to be limited thereby, but is to be determined by the claims which follow.

What is claimed is:

1. An image projection system comprising:
a plurality of terminal apparatuses; and
an image projection apparatus that acquires image data from each terminal apparatus via a communication path and projects an image based on the image data, wherein
the image projection apparatus includes:
an image acquisition unit that acquires a plurality of pieces of image data of images located in predetermined display regions of the respective terminal apparatuses via the communication path;
an image processing unit that combines the plurality of pieces of image data of the images located in the predetermined display regions of the respective terminal apparatuses; and
an image projection unit that projects an image based on composite image data generated by the image processing unit, and
the terminal apparatus includes:
an application program control unit that controls a predetermined application program;
an image generation unit that generates image data based on the application program controlled by the application program control unit;
a display control unit that controls display of an image based on the image data generated by the image generation unit and controls termination of the display;
a predetermined region image transmission unit that, when a position of the image based on the image data generated by the image generation unit is in the predetermined display region, partially or entirely transmits the image data of the image to the image projection apparatus via the communication path; and
an image display position change unit that changes the display position of the image to a display region other than the predetermined display region, on conditions that the display control unit terminates in the predetermined display region the display of the image generated based on the application program controlled by the application program control unit, and the image generation unit generates the image based on the application program again.

2. The image projection system according to claim 1, wherein
the terminal apparatus includes:
a display unit that displays the image based on the image data generated by the image generation unit; and
a virtual display region setting unit that sets, as the predetermined display region, a virtual display region adjoining to a display region of the display unit.

3. The image projection system according to claim 1, wherein
the terminal apparatus includes an image position determination unit that determines whether or not the position of the image, of which the display is terminated by the display control unit, is in the predetermined display region.

4. The image projection system according to claim 3, wherein
the terminal apparatus includes an image position storage unit that, when the display control unit terminates the display, stores the position of the image,
the image position determination unit of the terminal apparatus, when the display control unit terminates the display, determines whether or not the position of the image, which is stored in the image position storage unit, is in the predetermined display region, and
the image display position change unit of the terminal apparatus, when the image position determination unit determines that the position of the image is in the predetermined display region, updates the position of the image, which is stored in the image position storage unit, as the display region other than the predetermined display region.

5. The image projection system according to claim 3, wherein
the terminal apparatus includes an image position storage unit that, when the display control unit terminates the display, stores the position of the image,
the image position determination unit of the terminal apparatus, when the display control unit terminates in the predetermined display region the display of the image generated based on the application program controlled by the application program control unit, and then the image generation unit generates the image based on the application program again, determines whether or not the position of the image, which is stored in the image position storage unit, is in the predetermined display region, and
the image display position change unit of the terminal apparatus, when the image position determination unit determines that the position of the image is in the predetermined display region, updates the position of the image, which is stored in the image position storage unit, as the display region other than the predetermined display region.

6. The image projection system according to claim 1, wherein
the terminal apparatus includes:
an image display area detection unit that detects increase/decrease of a display area of the image in the predetermined display region; and
an image termination determination unit that determines whether or not the display control unit terminates the display of the image in the predetermined display region, based on a result of the detection by the image display area detection unit.

7. The image projection system according to claim 1, wherein
the terminal apparatus includes:
an image display area detection unit that detects increase/decrease of a display area of the image in the predetermined display region; and
an image generation determination unit that determines whether or not the image generation unit generates the image in the predetermined display region, based on a result of the detection by the image display area detection unit.

8. The image projection system according to claim 1, wherein
the image projection apparatus includes an image position determination unit that determines whether or not the position of the image, of which the display is terminated by the display control unit, is in the predetermined display region.

9. The image projection system according to claim 8, wherein
the terminal apparatus includes:
an image position storage unit that, when the display control unit terminates the display, stores the position of the image; and
a termination information transmission unit that, when the display control unit terminates the display, transmits termination information about termination of the display of the image to the image projection apparatus via the communication path,
the image position determination unit of the image projection apparatus determines whether or not the position of the image, which is stored in the image position storage unit, is in the predetermined display region upon reception of the termination information from the terminal apparatus via the communication path,
the image projection apparatus includes an image position shift information transmission unit that, when the image position determination unit determines that the position of the image is in the predetermined display region, transmits image position shift information about shift of the position of the image to the terminal apparatus via the communication path, and
the image display position change unit of the terminal apparatus updates the position of the image, which is stored in the image position storage unit, as the display region other than the predetermined display region upon reception of the image position shift information from the image projection apparatus via the communication path.

10. The image projection system according to claim 8, wherein
the terminal apparatus includes a generation information transmission unit that, when the image generation unit generates the image, transmits generation information about generation of the image to the image projection apparatus via the communication path,
the image position determination unit of the image projection apparatus determines whether or not the position of the image generated by the image generation unit is in the predetermined display region upon reception of the generation information from the terminal apparatus via the communication path,
the image projection apparatus includes an image position shift information transmission unit that, when the image position determination unit determines that the position of the image is in the predetermined display region, transmits image position shift information about shift of the position of the image to the terminal apparatus via the communication path, and
the image display position change unit of the terminal apparatus changes the display position of the image to the display region other than the predetermined display region upon reception of the image position shift information from the image projection apparatus via the communication path.

11. The image projection system according to claim 1, wherein
the image projection apparatus includes:
an image projection area detection unit that detects increase/decrease of a display area of the image projected by the image projection unit; and
an image termination determination unit that determines whether or not the display control unit terminates the display of the image in the predetermined display region, based on a result of the detection by the image projection area detection unit.

12. The image projection system according to claim 1, wherein
the image projection apparatus includes:
an image projection area detection unit that detects increase/decrease of a display area of the image projected by the image projection unit; and
an image generation determination unit that determines whether or not the image generation unit generates the image in the predetermined display region, based on a result of the detection by the image projection area detection unit.

13. The image projection system according to claim 1, wherein
the image projection apparatus includes:
an image operation command acquisition unit that acquires an image operation command for operating a predetermined image among the images projected by the image projection unit;
an image operation command determination unit that determines whether or not the image operation command acquired by the image operation command acquisition unit is an image termination command for terminating display of the image; and
an operation command processing unit that, when the image operation command determination unit determines that the image operation command is the image termination command, transmits an image termination command for shifting the image to the display region other than the predetermined display region to terminate the display of the image to the terminal apparatus, which has transmitted image data of the image to be operated based on the image operation command, via the communication path, and
the display control unit, upon reception of the image termination command from the image projection apparatus via the communication path, shifts the image to the display region other than the predetermined display region to terminate the display of the image in accordance with the image termination command.

14. A terminal apparatus comprising:
an application program control unit that controls a predetermined application program;
an image generation unit that generates image data based on the application program controlled by the application program control unit;
a display control unit that controls display of an image based on the image data generated by the image generation unit and controls termination of the display;
a predetermined region image transmission unit that, when positions of the image based on the image data generated by the image generation unit is located in the predetermined display region, partially or entirely transmits the image data of the image to the image projection apparatus via the communication path, in order that an image projection apparatus acquiring a plurality of pieces of image data from a plurality of terminal apparatuses via a communication path and projecting images based on the plurality of pieces of image data, projects an image obtained by combining the images located in predetermined display regions of the respective terminal apparatuses; and
an image display position change unit that changes the display position of the image to a display region other than the predetermined display region, on conditions that the display control unit terminates in the predetermined display region the display of the image generated based on the application program controlled by the application program control unit, and the image generation unit generates the image based on the application program again.

15. A computer-readable recording medium recording a program for allowing a computer to function as:
image generation means for generating image data based on an application program;
display control means for controlling display of an image based on the image data generated by the image generation means and controlling termination of the display;
predetermined region image transmission means for, when a position of the image based on the image data generated by the image generation means is in the predetermined display region, partially or entirely transmitting the image data of the image to the image projection apparatus via the communication path, in order that an image projection apparatus acquiring a plurality of pieces of image data from a plurality of terminal apparatuses via a communication path, and projecting images based on the plurality of pieces of image data, projects an image obtained by combining the images located in predetermined display regions of the respective terminal apparatuses; and
image display position change means for changing the display position of the image to a display region other than the predetermined display region, on conditions that the display control means terminates in the predetermined display region the display of the image generated based on the application program, and the image generation means generates the images based on the application program again.
